(19) United States
(12) Patent Application Publication
(10) Pub. No.: US 2010/0332522 A1
(43) Pub. Date: Dec. 30, 2010

(54) METHODS AND SYSTEMS FOR MOBILE INFORMATION RETRIEVAL AND DELIVERY

(76) Inventor: John Wilson Steidley, Solon, OH (US)

Correspondence Address: BUCKLEY, MASCHOFF & TALWALKAR LLC, 50 LOCUST AVENUE, NEW CANAAN, CT, 06840, US

(21) Appl. No.: 12/818,624

(22) Filed: Jun. 18, 2010

Related U.S. Application Data
(60) Provisional application No. 61/218,582, filed on Jun. 19, 2009.

(51) Int. Cl. G06F 15/16; G06F 17/30; H04W 4/00

(52) U.S. Cl. 707/769; 709/217; 455/466; 707/E17.014

(57) ABSTRACT

Systems, methods, apparatus, computer program code, and means for delivering information are provided which include transmitting a notification of a learning path to at least one of a plurality of users, each of the users operating a mobile device, the notification including a text message associated with the learning path, receiving, from the at least one of a plurality of users, a first message in response to the notification, identifying, based on the first message, a status of the user, and identifying, based on the first message and the status of said user, a response to the first message.

### CROSS-REFERENCE TO RELATED APPLICATION

The present application claims benefit of and priority to U.S. Provisional Patent Application Ser. No. 61/218,582 filed on Jun. 19, 2009 and entitled “Methods and Systems for Mobile Information Retrieval and Delivery”, the contents of which are incorporated herein by reference for all purposes.

### FIELD

Embodiments relate to systems and methods for information retrieval and delivery in mobile systems.

### BACKGROUND

Business professionals, including sales and support personnel, are suffering from information overload. With information doubling every 2 years, global competition intensifying and budget constraints on support personnel under strain, it is no wonder that “today's professionals spend 53% of their time seeking out information” as reported by the Center for Media Research.

Further, as sales, support, and other personnel become more mobile and distributed, it can be difficult for an organization to distribute critical business information when, and where needed. As an illustrative example, consider the information needs of medical equipment sales representatives. These sales people are typically sent out on field sales calls to discuss highly complex equipment with prospective customers. A sales representative may be presented with a number of different technical or operational questions, and may not have the answers to all of them. It would be desirable to provide systems and methods which allow such individuals to quickly and easily obtain the answers to such questions. It would further be desirable to provide systems and methods for organizing, maintaining, and delivering information on demand.

### BRIEF DESCRIPTION OF THE DRAWINGS

FIG. 1 is block diagram of a system according to some embodiments of the present invention.

FIG. 2 is a further block diagram of a system according to some embodiments of the present invention.

FIG. 3 is a block diagram depicting a learning path pursuant to some embodiments.

FIG. 4 is a block diagram depicting multiple learning paths pursuant to some embodiments.

FIG. 5 illustrates a learning object in accordance with some embodiments of the invention.

FIG. 6 illustrates a portion of a data table according to some embodiments of the invention.

FIG. 7 illustrates a portion of a further data table in accordance with some embodiments of the invention.

FIG. 8 is a flow diagram of a method in accordance with some embodiments of the present invention.

FIG. 9 is a flow diagram of a further method in accordance with some embodiments of the present invention.

FIGS. 10-11 illustrate a series of graphical user interfaces in accordance with some embodiments of the present invention.

### DESCRIPTION

Embodiments of the present invention provide systems, methods, apparatus and means for delivering business information to a wide variety of different types of users operating a wide variety of types of devices to consume and interact with the information. As used herein, a remote learning system is described which provides on-demand delivery of business and other information to a mobile or distributed workforce. Pursuant to some embodiments, a user may interact with the remote learning system using any of a number of different client devices, including, for example, a telephone, a smart phone, an email client, a portable computer, a desktop computer, or other device allowing voice, data, or Internet communication. Pursuant to some embodiments, users are provided information in a structured manner, allowing the users to request and consume information on an as-needed basis while being presented the information in a structured manner.

A number of terms are used to describe features of the present invention. For example, as used herein, the term “client” is used to refer to a device operated by a user to interact with a remote learning system of the present invention. The term “learning path” is used to refer to a sequence or series of content items designed or constructed to guide a user through a desired course of instruction or learning. The term “learning object” is used to refer to a single item of content. A “learning path” has a number of interrelated “learning objects” configured in a manner allowing a structured presentation of information. Each learning object is defined by meta data defining the relationship of the object to other learning objects and further defining the nature of data associated with the learning object. Each learning object may include a discrete item of content that may be consumed or used by a client upon request by a user. Learning objects may be arranged in a group as a “learning step” within a learning path (which may consist of one or more learning steps). Further, a number of “learning paths” may be grouped together as a “learning program”.

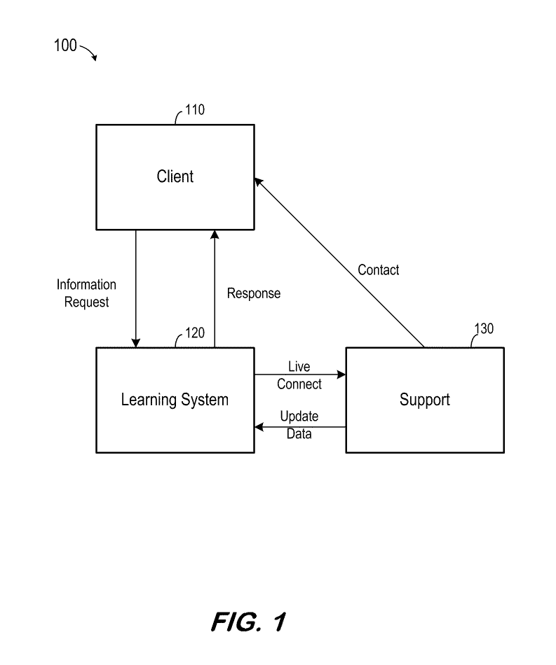

Features of some embodiments will now be described by first referring to FIG. 1 which is a block diagram of a system 100 pursuant to some embodiments. As shown, a system 100 of the present invention includes a client device 110 in communication with a learning system 120. The client device 110 may initiate communication with learning system 120 by submitting an information request and the learning system 120 may provide a response to the request. As will be described further herein, the learning system 120 may also push information to the client device 110 (that is, the client device 110 need not initiate an information request in order to receive information). In some situations, the information requested by the client device 110 may not be readily available in the learning system 120, and a live connect request may be made from the learning system 120 to a support operator 130. In such situations, the learning system 120 may request that a particular subject matter expert (“SME”) enter into a live connection directly with the user (e.g., by placing a phone call to the user, by entering into a chat session with the user, or the like). In some situations, a user operating a client device may specifically request a “live connect” with an SME or other support operator.

Although only a single client device 110, learning system 120 and support system 130 are shown in FIG. 1, pursuant to some embodiments, a system 100 may involve interaction between multiple devices. More particularly, in a typical implementation, a number of client devices 110 may be in communication with each learning system 120. Each client device 110 may be any of a number of different types of devices. Pursuant to some embodiments, system 100 allows users operating different types of client devices 110 to receive, request, and interact with information provided by learning system 120. Client devices 110 may be mobile telephones, landline telephones, computer systems, laptop computers, smart phones, or the like. For example, in a typical implementation, a user may interact with learning system 120 using a mobile telephone or smart phone while he or she is traveling or at a client location, and may also interact with learning system 120 using a desktop computer while in the office or at home. Embodiments allow users to interact with and consumer learning information in a variety of different contexts or locations, by allowing the information to be delivered to a variety of different client devices 110. Each user may be connected with one or more supporters.

Learning system 120 may be configured as a Web server (or group or network of Web servers) allowing communication with a variety of different client devices. In some embodiments, learning system 120 stores, or has access to, learning data stored as a number of learning objects, where the learning objects have logical and defined connections to form one or more learning paths. A user operating a client device 110 may access a learning object by navigating a learning path (assuming the user is given adequate permissions to access the learning path). Pursuant to some embodiments, learning system 120 further includes administrative and authoring features which allow administrative or authoring privileges to be granted to certain users so that learning paths and learning objects may be constructed for access by users.

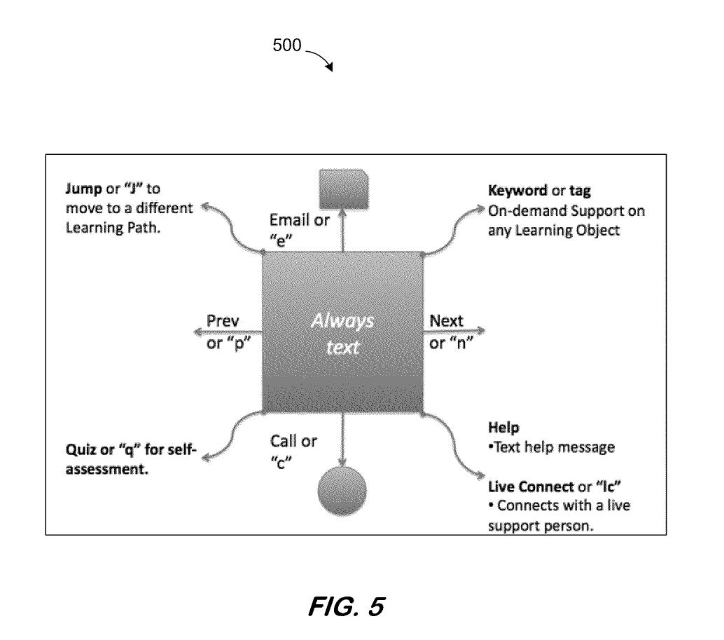

Pursuant to some embodiments, the learning system 120 may drive content and information to users operating mobile devices by providing on-demand delivery of critical or useful business information to the user's mobile device. In one currently preferred embodiment, a user may be alerted to or informed of content or learning objects by sending a text message to a mobile device associated with the user. The user, by interacting with the text message, may interact with a learning object and a learning path by responding to the text message in one of a number of ways. Further details of the responses or navigational aspects of the present invention will be provided further below in conjunction with FIG. 5.

By allowing learning objects and learning paths to be navigated based on information received and transmitted via text messaging, embodiments allow a mobile workforce to access needed information in a timely manner.

For example, one intended use of the system of the present invention is to deliver timely, accurate and relevant business information directly to the mobile phones of the field sales force of clients. The on-demand availability of information allows a sales team to react faster, be more competitive and execute on their business critical mission of profitable growth.

Embodiments address problems in information delivery and access by providing sales teams ready access to client supplied information such as target markets, key messages, competitive positioning, essential specifications and a decoding of buzzwords and acronyms. Information is delivered directly to their mobile phone as these devices have become the “always on, always available” business tool for today's army of field workers.

Pursuant to some embodiments, in operation, a mobile sales professional (operating a mobile device as client device 110) sends an SMS text message to request content and the learning system 120 responds with the content. The learning system 120 may respond to a request by delivering a pre-recorded text, voice or video message. The learning system 120 may also respond to a request by delivering an email or link to additional content associated with the request.

Pursuant to some embodiments, if the requested information is available, the learning system 120 responds with the information and the mobile worker enjoys accurate, timely and relevant information without any intervention of support personnel—saving time and money. If information is not available the request is routed directly to an existing supporter allowing the normal support process to proceed unabated. For example, in some embodiments, a “live connect” option is available where no existing information is available within the learning center 120. In a live connect option, a user requesting information may be instantly connected with a knowledgeable support representative or other subject area expert. In some embodiments, the learning system 120 automatically logs requests to identify areas where content needs to be added to support other users. Thus, the learning system 120 tracks what additional content is needed for the future.

In addition, in some embodiments, users may be encouraged to add “social tags” to the content to improve information retrieval by other users. Users may also comment on the relevancy of content in pursuit of their mission. By identifying both high and low quality content appropriate actions can be taken to improve the overall level of information provided to the entire field team. Clients can now tap into the “social network” of field users in a systematic, structured way and improve their competency as a learning organization.

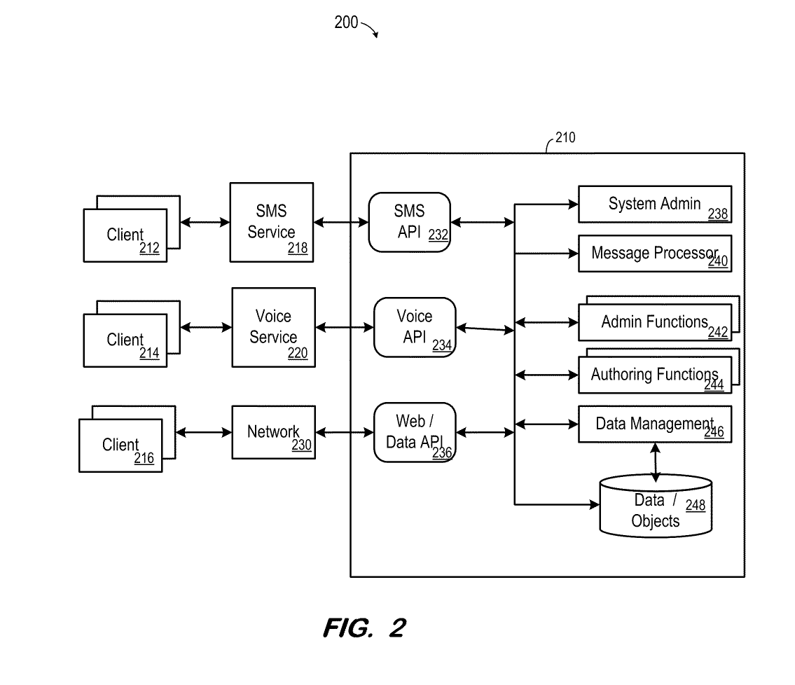

Further features of some embodiments will now be described by reference to FIG. 2 where further details of a system 200 pursuant to some embodiments are shown. As shown, system 200 includes a number of client devices 212 in communication with a learning system 210 via a short messaging system (“SMS”) service 218, a number of client devices 214 in communication with learning system 210 via a voice service 220, and a number of client devices 216 in communication with learning system 210 via a network 230. Each of the client devices 212-216 may be, for example, mobile devices such as mobile telephones or smart phones, computers (such as desktop, laptop, or other computing devices), and, in the case of client 214, may also be landline or other telephones. Pursuant to some embodiments, the learning system 210 is able to transmit learning objects and information to a wide variety of user devices over a wide variety of different communication paths so that users may readily receive learning information where and when they need it.

By providing a number of different communications paths (e.g., through services 218-230), embodiments allow users to receive and request information as they need it, from different devices depending on their need. A user who needs information about a specific topic may obtain it from a mobile phone, from a wired telephone, from a computer, or the like. In this manner, distributed sales forces and other users may receive and interact with information as needed.

System 200 includes a learning system 210 which may be implemented as a Web server or other computing platform as discussed above. learning system 210 includes a number of components or software modules including a system administrator module 238, a message processor module 240, a variety of administrative function modules 242, authoring function modules 244, and data management modules 246. The data management modules 246 allow access and interaction with a number of data tables or data stores 248, including data associated with one or more learning objects and learning paths (as will be described below). learning system 210 also includes (or is in communication with) a number of application programming interfaces (“API”) or interface devices, including an SMS API 232, a voice API 234, and one or more Web or data APIs 236. Each of the APIs allow two way communication between communication services and the learning system 210. For example, the SMS API 232 allows the learning system 210 to transmit SMS messages to a number of client devices 212 through one or more SMS services 218. Further, the SMS API 232 allows the learning system 210 to receive and process SMS messages received from client devices 212. The APIs 234 and 236 provide similar integration for voice, data and other interactions.

In some embodiments the SMS API 232 may be one offered by ClickATell.com (or any similar SMS gateway having an API allowing messages to be transmitted and received). In some embodiments, the voice API may 234 may be an XML-based API such as the one provided by VoiceShot LLC or similar systems.

Although the devices of system 200 are depicted as communicating via dedicated connections, it should be understood that all illustrated devices may communicate with one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

The learning system 210 of the present invention might, for example, comprise a platform or engine (portions of which may be implemented as a Web server) and may comprise one or more processors (such as one or more INTEL® Pentium® processors), coupled to communication devices including the APIs 232-236 allowing the learning system 210 to communicate via one or more communications networks. The communication devices may be used to transmit learning information to one or more client devices 212-216 as well as to receive requests for information, rating, reviews and feedback from those client devices.

The processor(s) of the learning system 210 are also in communication with one or more input devices, allowing interaction with functions such as the system administrator module 238 and the like. The input devices may comprise, for example, a keyboard, a mouse, or computer media reader. Such an input devices may be used, for example, to enter information about new learning paths, existing learning paths, learning objects, or the like. The processor may also be in communication with one or more output devices such as, for example, display screens, printers or the like. The output devices may be used, for example, to print, edit, or otherwise view data associated with learning paths, learning objects or the like.

The processor(s) of the learning system 210 are also in communication with one or more storage devices, including the data/object store 248. The data/object store 248 (as well as other storage devices associated with the learning system 210) may comprise any appropriate information storage device, including combinations of magnetic storage devices (e.g., hard disk drives), optical storage devices, and/or semiconductor memory devices such as Random Access Memory (RAM) devices and Read Only Memory (ROM) devices.

The storage devices store programs for controlling the processor to cause the learning system 210 to operate in accordance with any embodiments of the present invention described herein. For example, programs may be provided to perform the administrative functions associated with the system administrator modules 238, the authoring functions of the authoring functions module 244, etc.

As used herein, information may be “received” by or “transmitted” to, for example: (i) the learning system 210 from other devices; or (ii) a software application or module within the learning system 210 from another software application, module, or any other source.

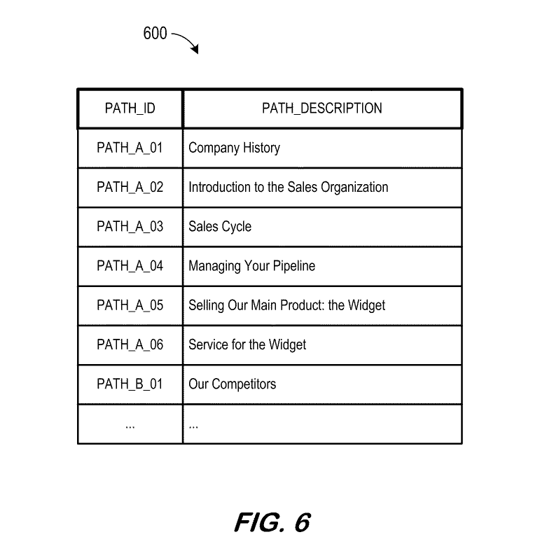

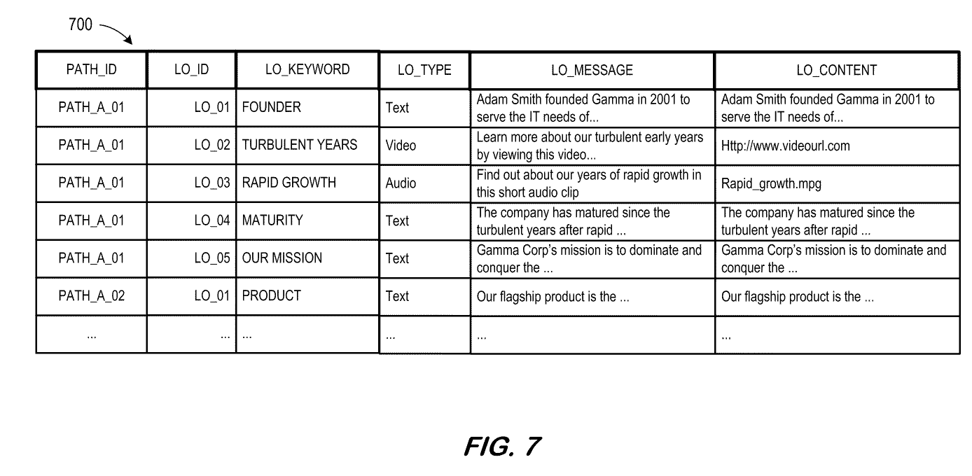

The data/objects 248 stored at (or accessible to) learning system 210 may include a number of data tables or data stores which store data associated with learning paths and learning objects. Example data associated with a learning path and learning objects in the learning path will be described further below in conjunction with FIGS. 6 and 7.

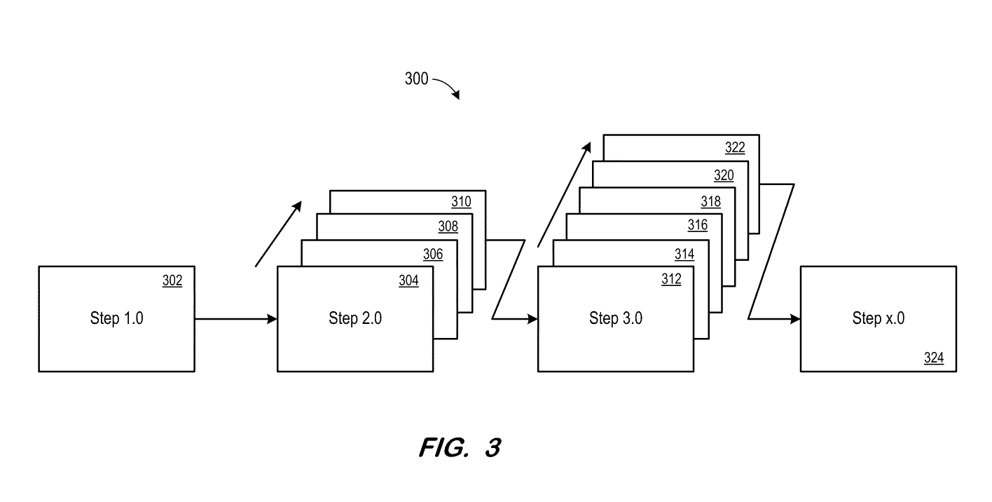

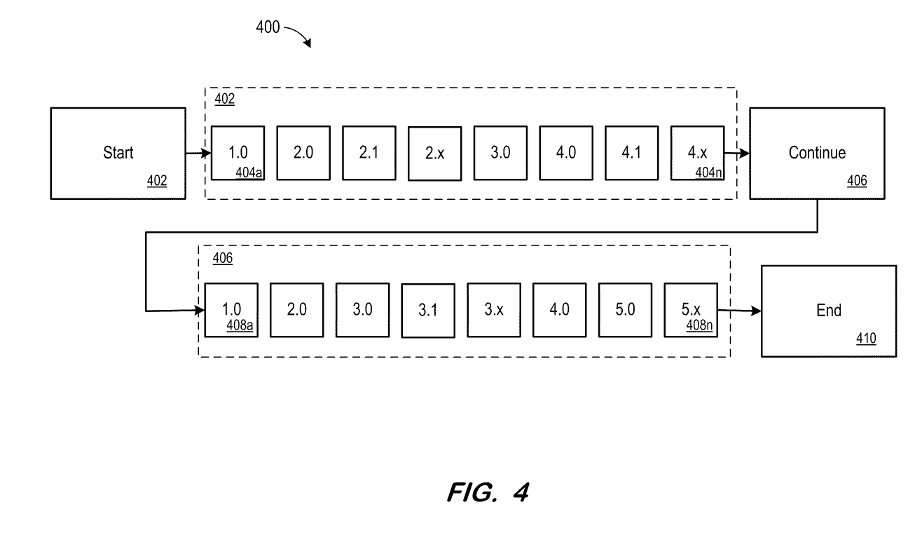

Prior to a discussion of such data stores and examples of data that may be contained in learning objects pursuant to the present invention, reference will first be made to FIGS. 3-5 which depict example structures representing various embodiments of a learning path (FIGS. 3-4), and a representation of a learning object (FIG. 5) and the navigational commands associated with individual learning objects.

Referring first to FIG. 3, an example learning path 300 is shown which includes a number of steps (302-324). Each step in the path may consist of one or more learning objects which contain information to be presented to an end user about a topic or “keyword”. Users who have permissions to navigate the learning path 300 may do so in a structured manner by following the path linkage or sequencing. The sequencing of the example learning path 300 is represented by the arrows. For example, a user navigating the path may begin at the first step 302 and proceed sequentially to the completion of the path at 324. Each of the steps may be grouped into a topic area having multiple learning objects in the step. For example, the step identified as “2.0” has four learning objects associated with it (items 304-310). A user's navigation along the learning path may be cookied or identified (e.g., if a user has viewed items 304-308, but not 310, a cookie or flag may be set to indicate that the user needs to complete item 310 to complete the step “2.0”). Pursuant to some embodiments, an administrator of a client may define the steps and learning objects associated with a learning path, and may add, delete or modify learning objects and the path as needed to provide a desired sequence of information.

Referring now to FIG. 4, a further representation of a learning path 400 is shown in which the learning path 400 is constructed from a join of two separate learning paths 402, 406. Further, the path 400 is provided with connectors and terminators, including a “start” module, a “continue” and an “end” module. These connectors and terminators may be used by a creator or administrator of a learning path to provide a connection between two or more paths. In this manner, embodiments allow administrators, authors or other users with sufficient privileges to easily create, link and deploy learning paths pursuant to the present invention.

Pursuant to some embodiments, the basic building block of learning paths and information of the present invention are the learning objects. Learning objects may be the lowest level of granularity in the learning system, and may consist of data identifying an objective of the learning object, content associated with the learning object, and assessement data associated with the learning object (including any feedback or comments received about the learning object). Each learning object also includes meta data defining the object's relationship with other learning objects. Further, each learning object includes a number of navigational features allowing navigation between learning objects and within a learning path. For example, such navigational features are important where client devices used to interact with a learning system include mobile phones and devices which allow a user to view learning object content using SMS or text messages. An example of one currently preferred navigational structure is shown in FIG. 5.

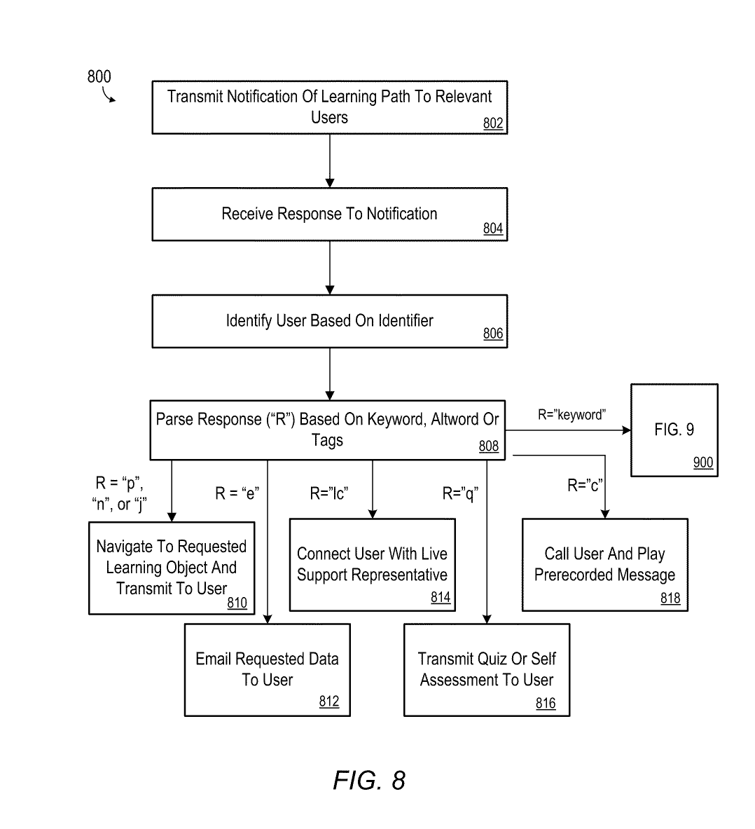

As shown in FIG. 5, a learning object 500 is depicted. Learning object 500 has a number of navigational features and other commands associated with it, and these navigational features and commands allow learning objects to be used as the basic building block of learning paths of the present invention. Further, as will be described further below in conjunction with FIG. 8, these navigational features and commands allow the system to transmit new or relevant learning objects to a user operating a mobile device as a text message. The user may interact with the information associated with the learning object by responding with one or more navigational or other commands to receive further information, to navigate to other learning objects along a learning path, to receive additional support (such as to connect with a live operator or subject matter expert), to perform a self-assessment or quiz, or to request additional information based on a keyword or tag.

Those skilled in the art will appreciate that other navigational features or commands may be provided. The commands shown and discussed herein are not limiting or exhaustive. Instead, pursuant to embodiments of the present invention, any of a number of commands may be provided to allow users operating mobile devices to interact with deep sources of content and to obtain other information. As embodiments allow such navigation and interaction from mobile devices using text messaging, users enjoy an ability to obtain detailed and relevant information when and where they need it.

Reference is now made to FIGS. 6 and 7 which show portions of data tables that may be stored at, for example, datastore 248 of FIG. 2 and which are used to define learning paths (FIG. 6) and learning objects (FIG. 7). Those skilled in the art will appreciate that other data fields and tables will likely be used to fully define and describe learning paths and learning objects and that the portions of tables shown are for illustrative and explanatory purposes only. FIG. 6 is a tabular view of a portion of a learning path data table 600 in accordance with some embodiments of the present invention. The table 600 includes a number of entries identifying different learning paths that have been created for use in the system 200 of FIG. 2. For example, the learning paths may have been created by or for a client company using the present invention to provide information to its mobile workforce. The table 600 defines fields including, for example, a PATH_ID and a PATH_DESCRIPTION. The PATH_ID may be a system generated identifier that is used to uniquely identify different learning paths created in the system. The PATH_DESCRIPTION is a text description of the content of the path.

The PATH_DESCRIPTION may be created (and updated or modified) by a system administrator or other user having sufficient privileges to create, modify or edit the learning path. As shown in the table 600, several learning paths have been created (“PATH_A” and “PATH_B”), one of which has multiple learning steps or related paths. The learning path identified as “PATH_A” has six different related learning steps (with descriptions ranging from “Company History” to “Service for the Widget”).

Referring now to FIG. 7, a portion of a learning object table 700 is shown which depicts a number of fields that may be used to identify individual learning objects associated with different learning paths (such as the learning paths of table 600). As shown, each learning object is identified by a LO_ID (or learning object identifier, which may be an identifier assigned by the learning system 210 when the learning object is created), and is associated with a learning path (identified by the PATH_ID). Each learning object has one or more keywords or tags (“LO_KEYWORD”) associated with it, and also have a data type (“LO_TYPE”) and associated content (“LO_CONTENT”). Further, pursuant to some embodiments, each learning object may have a short text description (shown as “LO_MESSAGE”). This short text description may be used to transmit an initial text message to mobile users notifying them of the existence of the learning object (or to describe the learning object when a mobile user navigates to the object). In this manner, users always know what they will get and can request to view or receive the full video or audio content when needed. For example, for a user operating a mobile device, the learning object identified as “LO_02” may be presented as an initial text message (with the text message including the messaging from “LO_MESSAGE”). Since the learning object is a video learning object, the text message may instruct the user how to view the video. In some embodiments, video content may be presented by sending a URL to the video content in the text message. In some embodiments, audio content may be delivered upon request of a mobile user by calling the mobile user and presenting a prerecorded message containing the audio content. For example, in some embodiments, an XML based voice messaging system such as the one provided by VoiceShot LLC may be used.

Pursuant to some embodiments, learning objects may be identified or searched by using keywords or tags (as described below) so that relevant information may be retrieved by a user operating a mobile or other device. For example, the learning object identified as “LO_01” will be identified if a user sends a text message to the learning system 210 with the keyword “founder”. Each learning object has content associated with it, including text, video, or audio. In some embodiments, combinations of different content may be stored in a single learning object.

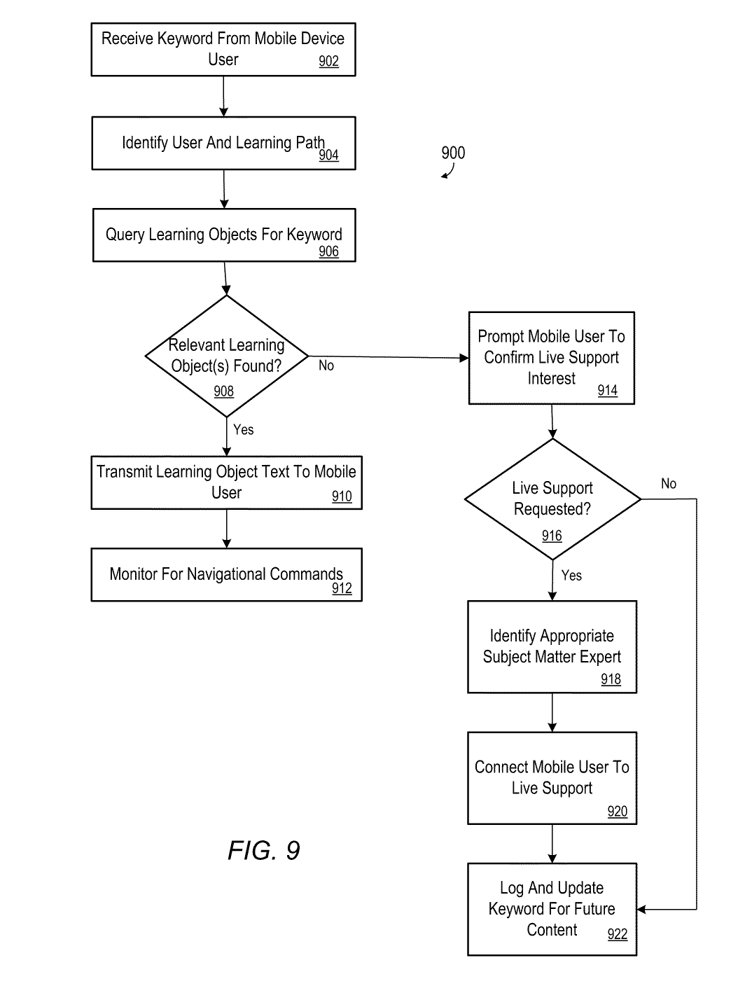

Embodiments of the present invention allow users operating mobile devices, such as mobile phones or other devices capable of communicating via SMS messages, to obtain learning path and learning object data on their mobile devices. Further, embodiments allow users to interact with such content and obtain additional or needed information using a simple and reliable process. Several processes for interacting with a learning system (such as system 210 of FIG. 2) will now be described by reference to FIGS. 8 and 9.

FIG. 8 illustrates a method 800 that might be performed, for example, by some or all of the elements of the system 200 described with respect to FIG. 2 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

Method 800 may be performed by the learning system 210 once an administrator has set up one or more learning paths for a client as well as one or more client employees or users. The method 800 is used by the learning system 210 to transmit information about learning objects to mobile users registered to receive the information from the learning system 210. The method 800 begins at 802 where the learning system 210 causes a notification of a learning path to be transmitted to relevant users. The process may be performed in a batch mode or each time a learning path has been created or updated so that users are notified of new or updated content as it is created (or when an administrator or manager determines that users should be notified of the content). “Relevant users” may be any employee or user who has been registered as a user of the learning system 210 who has permissions or rights to receive the information. The notification sent at 802 is, in some embodiments, transmitted using SMS messaging techniques to a mobile device associated with each relevant user (e.g., such as the mobile device identified by a user in a profile created in the learning system 210). For example, the notification may be sent to a number of different users by interacting with an SMS gateway or other messaging system (such as the SMS service 218 of FIG. 2).

Processing continues at 804 where the learning system 210 receives a response from a user. The response may be transmitted to the learning system 210 as a text message response to the notification sent at 802. The response may be received through a messaging system interface such as the SMS service 218 of FIG. 2. In some embodiments, the learning system 210 may be identified using an SMS shortcode (e.g., such as a 5-digit identifier or the like). In some embodiments, the learning system 210 may be identified using an SMS longcode (e.g., such as a 10-digit identifier or the like). Pursuant to some embodiments, the notification includes information identifying a navigational command or other response (such as a keyword, an altword, or a tag). Further, the notification includes information identifying the message (from 802) to which the response has been sent. This information is used by the learning system 210 to determine an appropriate action.

Processing continues at 806 where the user transmitting the response is identified. For example, in some embodiments, the learning system 210 may identify registered or participating users based on their mobile phone number or other identifier. This may be used to track progress of each user along a learning path, to log questions, to log responses or queries, as well as to confirm that the user has sufficient privileges to access or request certain data.

Processing continues at 808 where the response received from the mobile user is parsed to identify any received keyword, altword or tags. Pursuant to some embodiments, commands (such as navigational commands “n”, “p” or “j”) may be used by a mobile device operator to easily navigate along a learning path. For example, if the response includes (or is) the command “n”, the learning system 210 processes the character (or characters) as a command (at 810) to navigate to the requested learning object (in this case, the next learning object in the path) and to transmit the learning object to the mobile user. Similar navigation may occur upon receipt of the commands “p” or “j” (where a response with the “j” command may also include information identifying which learning object to jump or navigate to).

Processing at 808 may also include the receipt of a command“e” (or “email”) which signifies a request by the mobile user to email further information associated with the current learning object to the mobile user at 812. For example, a mobile user may respond with an “e” command if the notification at 802 included a note that additional materials about the learning object are available.

Processing at 808 may also include the receipt of a command “lc” or “live connect” which is interpreted by the learning system 210 as a request for live support. Processing at 814 includes identifying an appropriate operator or support representative (e.g., such as a subject matter expert associated with the content of the learning path transmitted at 802) and then establishing a telephone, SMS or chat communication session between the support representative and the mobile user.

Processing at 808 may also include the receipt of a command “q” or “quiz” which is interpreted by the learning system 210 as a request by the mobile user to take a quiz or self assessment. Processing in such a situation continues at 816 where the learning system 210 transmits a quiz or self assessment (if available for the current learning path) to the mobile user. In some embodiments, a self-assessment quiz may be used to drive additional user interactivity to cement the learning object into the working knowledge of the user. In some embodiments, while on a learning path, a command “q” may deliver a simple interactive quiz or assessment (e.g., such as a true/false set of questions). In some embodiments, such quizzes or self-assessments may be delivered using a browser of a client device rather than as a text message sequence. In some embodiments, the “q” command may return a survey, poll, questionnaire or a high stakes test to the mobile user. Those skilled in the art will appreciate that other forms of interactivity may also be used to increase the learning impact of the present invention.

Processing at 808 may also include the receipt of a keyword or tag in which case processing continues at 900 (of FIG. 9) where the learning system 210 processes the keyword or tag to identify relevant information to respond to the mobile user.

In this manner, embodiments of the present invention allow users operating mobile devices to interact with, consume and access rich content based on their specific and current needs. By allowing interacting communication with text messaging commands, users can easily access and request content as needed. In some embodiments, the content, information architecture and commands may be viewed using a book metaphor, where each “client” is a library and can be reached using a unique phone number or code. Each “category” is a bookshelf, and each “subject” is a book on the shelf. Each “topic” is a chapter in a book, and each “learning object” is a sub-topic in a chapter. In a training scenario, a “learning object” may be considered a single “teachable, testable” concept. Preferably, in some embodiments, each learning object may be easily consumed and understood in a few minutes. Continuing the book metaphor, a “keyword” is a chapter or topic, and within a book (or a subject), the keywords form a table of contents. Public “tags” or “altwords” form a public index to the book, and private tags act as individual user bookmarks. In some embodiments, “comments” may also be made by users operating their mobile devices, and these “comments” are similar to margin notes in the book metaphor. “Contributions” are more formal ideas submitted by mobile users to enhance the quality of the content.

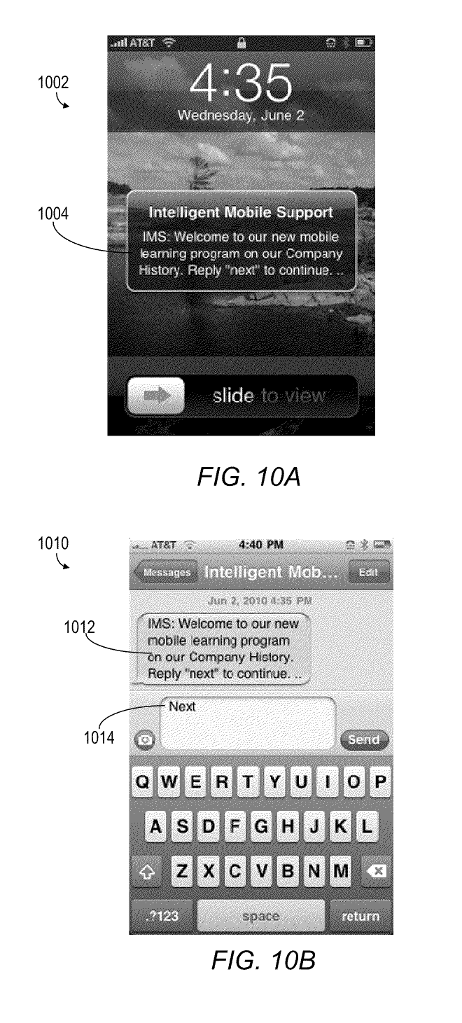

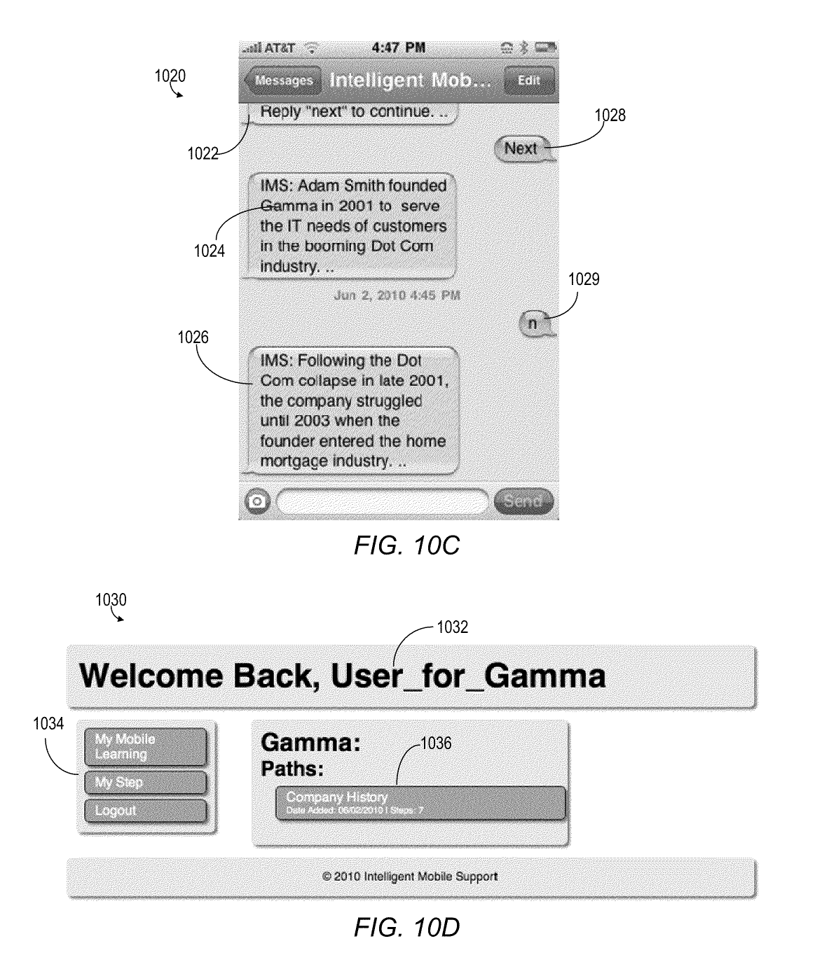

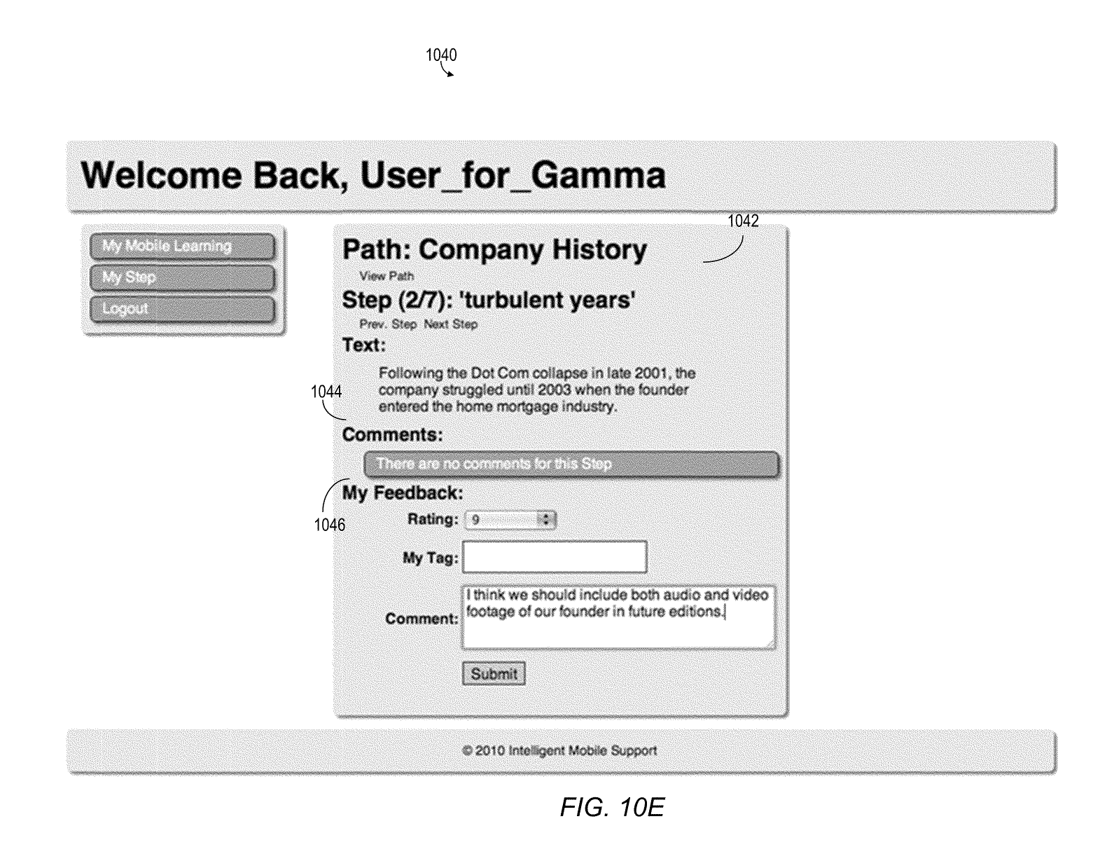

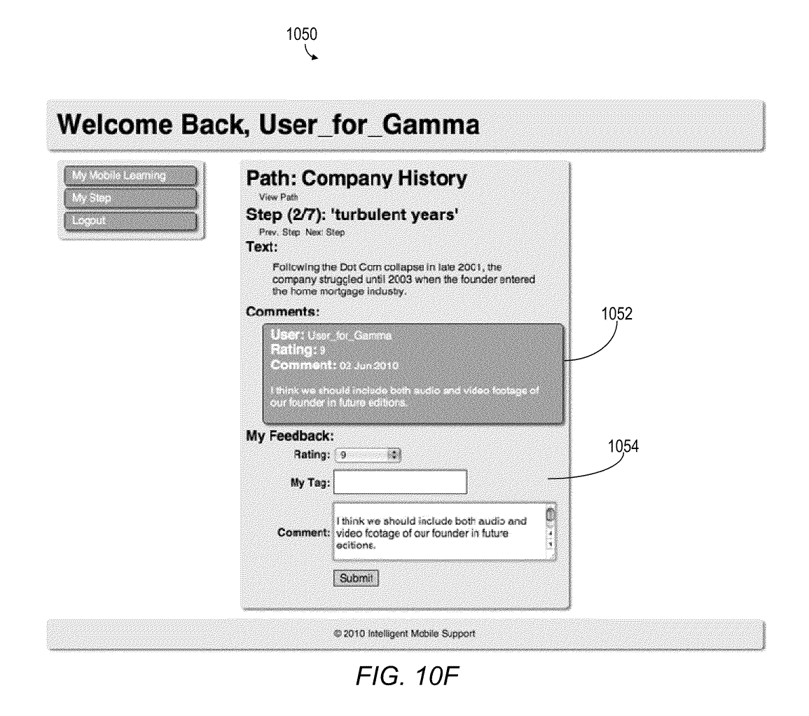

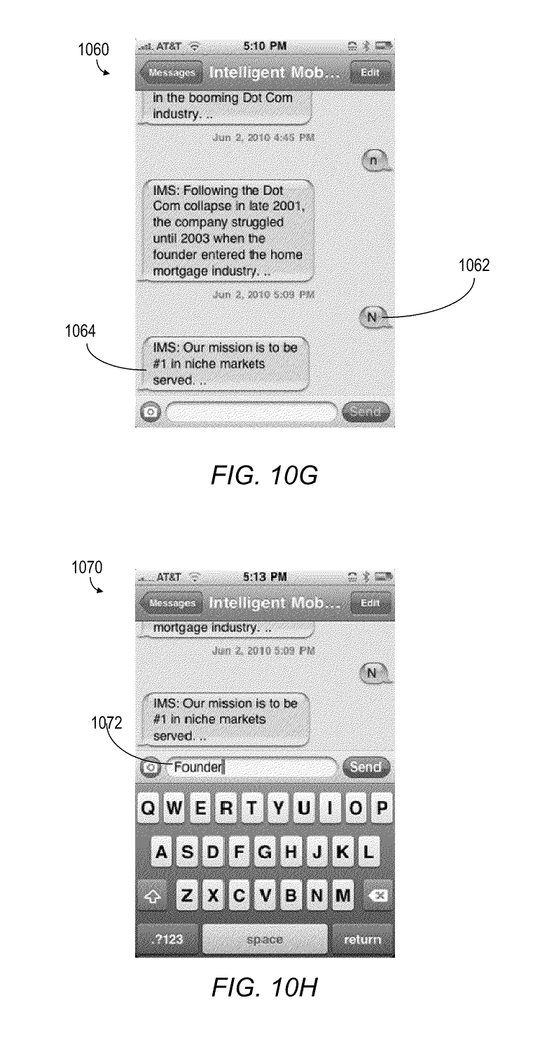

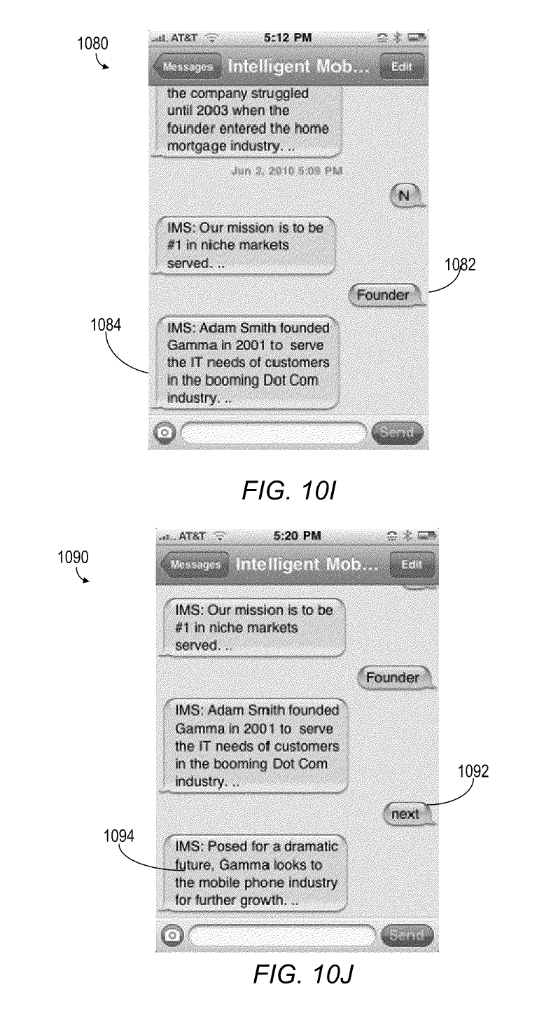

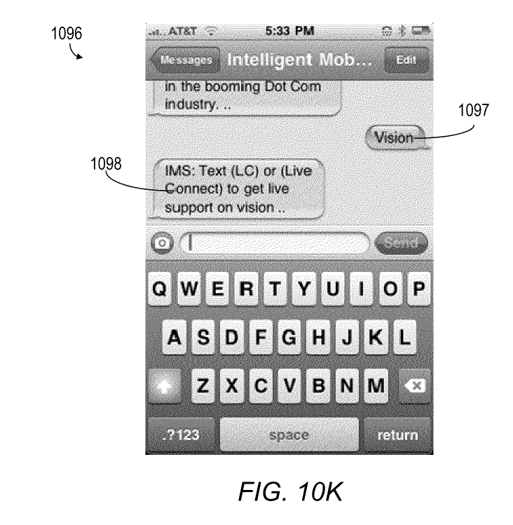

Reference is now made to FIG. 9 where a method 900 pursuant to some embodiments is shown. Method 900 is a method for processing information requests received from mobile devices by in a learning system such as the system 200 of FIG. 2. The method 900 may be performed by the learning system 210 in response to requests received from mobile devices operated by users registered to participate in the system of the present invention. Processing begins at 902 where the learning system 210 receives (e.g., via an SMS API 232 in communication with an SMS service 218) a keyword or tag received from a mobile device user (e.g., such as a user operating a client device 212). For example, the user may have been viewing a learning object or other information of the present invention (such as described in FIG. 8 above, or as depicted in FIG. 10), and the user may request additional information about a topic or item of information by transmitting keyword or tag to the learning system 210. At 904, the learning system 210 operates to identify the user and the current learning path (if applicable) to identify the current context of the user. Processing continues at 906 where the learning system 210 creates a database query to query learning objects for the received keyword (or tags). A determination is made at 908 if any relevant learning object(s) or other information have been found. If any have been found, processing continues at 910 where the learning system 210 creates a response message including the learning object text and transmits the response message to the mobile user. An example user interface with such a response is shown in FIG. 10I, below (e.g., where the user requested information about the keyword “founder” and the learning system 210 returned information displayed at 1084). The learning system 210 may then monitor to determine if any navigational commands or further requests are received from the mobile user.

If processing at 908 returns no relevant learning objects or other information, processing continues at 914 where the learning system 210 causes a prompt to be transmitted to the user to confirm whether the user would like to be connected to live support to answer their query or to get more information about the requested keyword or tag. At 916, a determination is made whether the user would like to be connected to live support. If so, processing continues at 918 and the learning system 210 identifies an appropriate operator to [[connect]] contact the user to (e.g., such as an appropriate subject matter expert). Processing at 918 may include steps such as consulting a directory of available representatives, determining if an appropriate representative is available for a live connect session, or the like. Processing continues at 920 where the learning system 210 connects the mobile user to the live support representative (e.g., by either initiating a conference call, or other voice connection, or by establishing a chat or text messaging session between the user and the support representative). Processing continues at 922 where the learning system logs and updates the keyword or tag for future content creation. In this manner, the learning objects and other information in the system may be updated to reflect actual queries and support requests made by users.

The system provides a way for users to quickly request and obtain relevant information based on keywords, tags and other queries. In the event data is not available to respond to a request, embodiments allow a user to be quickly connected to a knowledgeable support representative. In this manner, users obtain the information they need, when and where they need it.

Although the processes of FIGS. 8 and 9 have been described for use by users operating mobile devices, similar processes may be used in conjunction with other devices, such as desktop or notebook computers, tablet computers, or the like.

Reference is now made to a series of user interfaces shown in FIG. 10. These user interfaces are purely for illustration of features of some embodiments—those skilled in the art will appreciate that different layouts, configurations and information displays may be provided. As shown, each of the user interfaces of FIG. 10 may be displayed on either a mobile device (such as the user interface 1002 of FIG. 10A) or on a computer screen (such as the user interface 1030 of FIG. 10D). Similar information may be displayed on either type of device.

The user receives a text message from the learning system 210, which alerts a user that a new learning path is available, as shown in FIG. 10A. Item 1004 depicts a message presented to the user identifying the new content. After a user receives an announcement of a new learning path, they can receive the next step along the path by sending a SMS text reply with the word “Next” (or letter “n”) as shown in FIG. 10B (the notification received is shown at item 1012, and the command “next” is shown as being entered at item 1014).

To continue, the user may send another SMS text reply with an “N” or “next” (item 1029) to receive the next learning object (1026) as shown in FIG. 10C. If the path contains prerecorded audio the user's mobile phone will ring and the audio will be played directly to the user. At any time the mobile device user can also access the learning path via the Web (as a “WebUser”). An illustrative user interface that may be displayed to a WebUser is shown in FIG. 10D. The top of the user interface 1032 may include the user's name (here, “User_for_Gamma”) as well as navigational options 1034 and a list of learning paths 1036. Pursuant to some embodiments, the data sent to a mobile device (e.g., as a text message) and the data presented to a user viewing the data using a Web browser are synchronized, so that the user's interaction from SMS text messaging and the user's interaction by browsing and interacting via a Web browser are synchronized (such that any completed actions, feedback, or the like are preserved if the user switches interfaces). Thus, if the WebUser clicks on “My Step” they are immediately shown the next step in the path, in this case step 2 of 7 as shown in FIG. 10E (where the user who previously was interacting via text messaging has logged onto the learning system 210 using a Web browser 1040 and is viewing the same path 1042 which shows that the user is on step 2 of 7 of the path). The user interface allows interaction and feedback from the user. For example, the user may submit comments 1044 (and view comments), and feedback 1046 including providing ratings, tags or the like. If the user provides any feedback (such as comments or tags, etc.), and clicks “submit”, a screen such as the screen 1050 of FIG. 1OF may be shown in which the user comments and rating are displayed at 1052. Further feedback 1054 may be provided.

Assuming that the user interacting with the screen 1050 of FIG. 1OF clicked and viewed the next step, and then returns to the mobile device interaction, a screen such as the screen 1060 of FIG. 10G may be displayed in which the information associated with the subsequent step may be shown at 1064. The navigation command previously submitted by the user may be shown on the screen as well (such as at 1062) to provide the user with information about the trail of interaction. In some embodiments, data shown on the right side are SMS text messages that were sent from the mobile device, while data on the left side are SMS messages received from the learning system 210.

At any time a mobile (or Web) user may request information by keyword or tag. For example, if a mobile user texts the keyword “founder” as shown in FIG. 10H, the data is transmitted to the learning system 210 which locates (if possible) the object associated with the keyword “founder” and sends the appropriate information (content) to the user as shown in FIG. 10I (at item 1084). The user, following the on-demand support request and receipt of the response, can navigate from the position of the response. For example, as shown in FIG. 10J (at item 1092) the user submitted the navigational command “n” which caused the learning system 210 to return data associated with the next step on the learning path as shown in item 1094. That is, in some embodiments, requests for on-demand support, even from the existing learning path, do not disrupt the sequence.

In some situations, submission of a keyword or tag request will return no information. In those situations, embodiments allow a user to elect to be connected with a live support operator. Pursuant to some embodiments, such as shown in FIG. 10K, a user whose query or request triggers a potential connection with a live support person is prompted to confirm that they do wish to be connected (e.g., by presenting a further prompt for confirmation such as the entry of “lc” at 1098). Such confirmations allow embodiments to avoid undesired or unintentional connections with live support personnel. In some embodiments, a live connection is generated under a variety of circumstances. For example, the user may request information that is not available in the system database. When such a request occurs, such as a request for “vision” in the example shown in FIG. 10K, the system prompts to see if the user requires live support with a message telling the user to “Text (LC) or (Live Connect) to get live support on vision”.

Such a prompt is useful to avoid situations where a smart phone offers predictive spelling. In such cases, even correctly spelled acronyms often get converted to a real word prior to the user hitting the “Send” button. The prompt shown in FIG. 10K challenges the user to think twice before requesting live intervention. When a user does willingly choose a live connection the support personnel selected to conduct the support interaction may receive a text message to call or text the user as this is now perceived as a bona fide request for support. Pursuant to some embodiments, the learning system 210 uses a progressive search. The search first progresses through a user's private tags, then public keywords, then public tags, then authored content and then user comments to find a an object to match the user's request. Thus, a live connection occurs only when the progressive search fails.

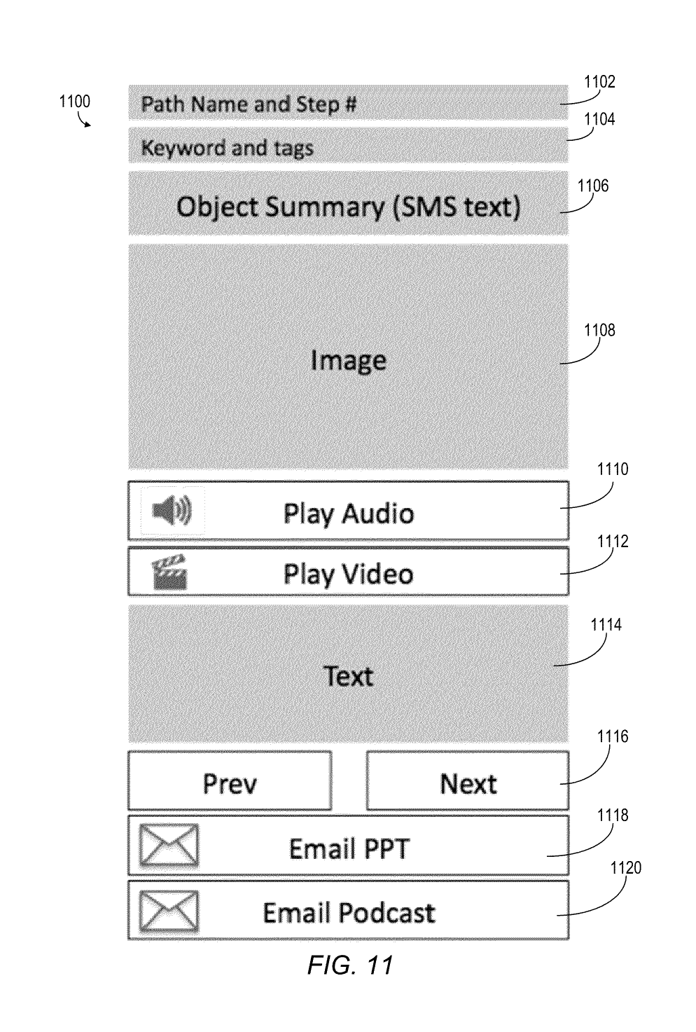

Pursuant to some embodiments, user interfaces may be provided with additional detail and content. For example, referring to FIG. 11, a user interface 1100 is shown which includes a variety of different types of information and navigational features that may be used with a smart phone. For example, learning objects may be constructed as combination objects consisting of images 1108, formatted text 1114, videos 1112, recorded audio 1110 and have additional content available which the learning system 210 can email to a user on-demand. These emails can contain any digital content and may typically consist of Microsoft Word, PowerPoint 1118, Excel or Adobe Portable Document Format (PDF) documents or audio files (also known as podcasts) 1120. The content may vary by client and among learning objects. Some objects may be just an image and text. Other objects may be just a video. All objects have an Object Summary which is used as the SMS text message 1106.

As an example, one embodiment of the learning system 210 shows graphics, text, embedded video and a link as elements of a combination object. This particular object is the first step of a learning path hence the only navigation button shown is the “Next” button. Pop-out screens to capture User Comments or engage Live Connect are also seen. Input boxes for “My Tags” and “Comments” plus a scroll box to select a rating are also rendered in the example shown in FIG. 36.

In the following description, illustrative use cases for five users (referred to herein as “actors”) of the learning system 210 are presented which illustrate the use and some functional requirements of the application. The following use cases and labels are provided for illustration purpose only, and are not intended to limit the foregoing disclosure. In general, the learning system 210 is an application that provides on-demand delivery of critical business information to a mobile worker of one or more clients. A number of “actors” are involved in an illustrative interaction using embodiments of the present invention. For example, a “SysAdmin” is a person (or “actor”) responsible for preparing the learning system 210 for client use. A “ClientAdmin” is a person (or “actor”) responsible for providing valid mobile device user information and entering content for each client. A “mobile device user” is a mobile worker (or “actor”) using the learning system 210 from a text enabled cell phone. A “WebUser” is a worker (or “actor”) using the learning system 210 from a PC or Smartphone using a browser over the Internet or an intranet. A “Supporter” is a person (or “actor”) assigned to receive text messages, email, direct phone calls, or other alerts (such as social networking alerts) from the mobile device user if the learning system 210 is unable to provide a response.

A number of items of “content” may be associated with embodiments of the present invention. For example, as used herein, “content” is an aggregate collection of pre-recorded text, voice and video information contained in a relational database. Each element of content (database record) is also referred to as a subject, topic or sub-topic when placed into an optional hierarchy or “content framework” that may be used to facilitate sequential browsing of content by a user.

A “keyword” is a unique identifier assigned by (for example) the ClientAdmin to each pre-recorded text, voice or video message in the learning content database. An “AltWord” is an alternative identifier (i.e., synonym of a keyword) to a keyword and is assigned by (for example) the ClientAdmin to facilitate retrieval. A “Tag” is an alternative identifier to a keyword or AltWord and is assigned by a mobile device user to further facilitate retrieval. “Tagging” is the process of assigning one or more alternative identifiers (tags) to the content. In social networking, this is also known as a “folksonomy” or collaborative tagging. The “learning content database” is the relational database that holds the subject, topics and sub-topics (text, voice and video files and metadata) provided by the Client. The “ContentFramework” is a Client supplied construct, or hierarchy, of subjects, topics and subtopics. This ContentFramework facilitates a navigational aid for sequential or ad hoc browsing by users. The Content Framework also acts as an outline for subject matter experts who provide the content.

A “LearningPath” (as depicted in FIG. 3) is a Client supplied sequence of subjects, topics and subtopics—a sub-set of the ContentFramework—and is intended to facilitate and track a user's progress through assigned or recommended topics. A “Difficulty” is a subjective rating assigned to each topic in the learning content database. The degree of Difficulty is used for reporting progress through a LearningPath, as some topics are more difficult or time consuming than others. Note that “0” (zero) indicates that the content is really just a placeholder heading such as “Glossary” and that the sub-topics in the Glossary contain information with varying degrees of Difficulty.

A “Status” is the user's percent completion through a LearningPath where the Difficulty factor is used to apply a weighting factor to each topic. For example, if the Learning Path has 20 topics of Difficulty 5 (20×5=100) and 25 topics of Difficulty 2 (25×2=50) the total path has a rating of 150. If 10 of each topic were reviewed (10×5=50) and (10×2=20) for a total of 70, then the status is 70 out of 150 or 47%.

A number of “users” are involved in the application, and a number of user-related terms are used herein. For example, a “UserDatabase” is a relational database that holds all the information (e.g., client names, user names, user phone numbers, group membership, email addresses) concerning Clients, mobile device users, Groups and Supporters. A “mobile device user#” is the phone number of mobile device user. A “MobiSupport#” is the phone number the mobile device user's supporter. A “ClientUser#List” is a list of all mobile device user numbers for a specific Client. A “LanguagePreference” is the Language preference of a mobile device user.

A number of communications networks may be used in conjunction with embodiments of the present invention. Communications may also involve the use of one or more gateways to bridge networks. For example, as used herein, an “SMSGateway” is a service that provides 2-way SMS text messaging service or communication between mobile device users and the learning system 210. The learning system 210 communicates with the gateway via SOAP messaging while the SMSGateway delivers text message via a public network of mobile carriers. As used herein, an “SMSGateway#” is a unique phone number for the SMSGateway assigned to each individual client. A “VoiceGateway” is a service that provides voice messaging service or communication from the learning system 210 to mobile device users. The learning system 210 communicates to the gateway via a SOAP message and the Gateway delivers the voice message via the public telephone network. The VoiceGateway stores voice files for triggered distribution to mobile device users. A “VideoGateway” is a service that provides video messaging service or communication from the learning system 210 to mobile device users. The learning system 210 communicates to the gateway via a SOAP message and the Gateway delivers the video message via the Internet. The VideoGateway stores video files for triggered distribution to mobile device users.

To facilitate communication and interaction using embodiments of the present invention, a number of messaging protocols and terms may be used. For example, “SOAP”—the Simple Object Access Protocol is one (typical) specification for exchanging information between computer networks. A “TextIn” is an inbound SMS text message from a mobile device user to the learning system 210 that triggers a response. Alternatively, the trigger could be an email, voice to text or instant message (IM). A “TextOut” is an outbound SMS text message from the learning system 210 to a mobile device user or Supporter. Alternatively, this could be an email, voice to text or instant message (IM). A “TimeStamp” is the date and time of a message. A “VoiceOutID” is an outbound voice message identification file name that uniquely identifies an audio file, such as a WAV (Waveform audio file format standard) that stores a prerecorded audio bit stream that enables a VoiceGateway provider to send an audio message to a mobile device user. A “VideoOutID” is an outbound video identification file name that uniquely identifies a prerecorded video, such as a MP4 (or more formally MPEG-4 Part 14 multimedia container format standard that allows video streaming over the Internet), to enable a VideoGateway provider to send a prerecorded video to a mobile device user. An “EmailOut” is an outbound email message to a mobile device user. A “Broadcast message” is a message sent to more than one mobile device user at a time.

A number of different log files and reports may be used in conjunction with embodiments of the present invention. For example, a “TextLog” is a record or file of all inbound and outbound SMS text messages as recorded by the SMSGateway. A “VoiceLog” is a record or file of all inbound requests and outbound Voice messages as recorded by the VoiceGateway. A “VideoLog” is a record or file of all inbound requests and outbound Video messages as recorded by the VideoGateway. Further, an optional “EmailLog” is a record or file of all inbound and outbound Email messages as recorded by the EmailGateway. An optional “IMLog” is a record or file of all inbound and outbound IM messages as recorded by the IMGateway. A “SysLog” is a record of all inbound and outbound messages as recorded by the learning system 210. A number of “UsageReports” may be created and distributed by the ClientAdmin to highlight content utilization, content rating and frequency of access by mobile device users. Based on these reports the client can take action to improve existing content, add new content or remove or replace poorly rated content.

To avoid programming and usage conflicts, a number of reserved system words may be defined. The following reserved words are illustrative, but not exclusive or exhaustive. As used herein, “SysWords” are words that are reserved for use by the learning system 210; this means these cannot be used as keywords, AltWords or Tags. SysWords may include the following “help”, “rate”, “tag”, “status”, “next”, “support” (or other codes or commands such as shown in FIG. 5, etc.). Each of these SysWords may be internal to the learning system 210 but can be remapped (or optionally eliminated) for individual Clients. Each SysWord is mapped into the LanguagePreferences of the mobile device users.

Pursuant to some embodiments, a number of Actors are involved in transactions using embodiments of the present invention. In some embodiments, the five key actors involved in the use of the learning system 210 are the SysAdmin, ClientAdmin, mobile device user (text based cell phone use), WebUser (browser based use) and Supporter. Each is discussed briefly below.

Pursuant to some embodiments, a SysAdmin is a person who, in their primary role: (1) Inputs information to the learning system 210 to enable one or more clients to use the application. Such information includes the following for each client: (a) a 10-digit SMSGateway# (b) ClientAdmin username, (c) ClientAdmin password, (2) Alerts each ClientAdmin of the above information to initiate the client's actions, (3) Verifies integrity of learning system 210 performance, i.e., resolves any discrepancies among the various log files (TextLog, VoiceLog, VideoLog and SysLog), (4) Manages the billing process for assigned clients based upon utilization of the learning system 210 by users.

Pursuant to some embodiments, a ClientAdmin is a person who, in their first primary role, administers a user list as follows: (1) Logs into the learning system 210 with an assigned username and password provided by the SysAdmin, (2) Adds, modifies or deletes approved mobile device users by entering a user name, email address and mobile phone number for each intended user, (3) assigns a Supporter to each mobile device user (however, the mobile device user may add the Supporter information later on in the process), (4) Optionally, assigns one or more LearningPaths to a mobile device user, (5) Optionally, creates one or more User Groups, (6) Optionally, assigns a mobile device user to one or more User Groups, (7) Optionally, enters additional user contact information.

In their second primary role, manages the content in the learning system 210 as follows, pursuant to some embodiments: (1) Adds new content by assigning a keyword and selecting a data file consisting of text, voice or video media, (2) Indicates a content status such as, for example “in-process”, “approved” or “released”, (3) Optionally provides one or more AltWords, (4) Assigns a degree of difficulty (e.g., from 0 to 10), (5) Sequences topics into a ContentFramework, (6) Optionally, defines and sequences selected topics into one or more learning paths (such as shown in FIG. 3), (7) Optionally, sends out broadcast messages to alert mobile device users of new or revised content, (8) Optionally, creates and distributes usage reports on content utilization, content rating and frequency of access by mobile device users.

As used herein, a mobile device user is a mobile phone user who, in their primary role may: (1) Sends a SMS message (TextIn) to the learning system 210, (2) When successful, receives (from the learning system 210) one of the following (a) SMS message (TextOut), (b) Voice message (VoiceOut), (c) Video (VideoOut) either directly to their mobile phone or via email, (3) When unsuccessful, meaning that the learning system 210 cannot provide an appropriate response, the text request may be sent directly to the Supporter.

In addition to the primary function of on-demand retrieval of business information each mobile device user can perform the following secondary functions (in addition to those discussed elsewhere herein) from a mobile phone using the following text based command language: (i) “Help” to request help, (ii) “Rate” to rate a topic, (iii) “Tag” to tag a topic, (iv) “Status” to check status, (v) “Next” to request the next topic on their learning path, (vi) “Support” to request the name of the assigned support personnel, (vii) “Support On/Off” to toggle support on or off and (viii) “Support new_number” to assign support to ‘new_number’ provided ‘new_number’ is a valid mobile device user mobile phone number.

In some embodiments, these secondary functions will normally be accomplished while the worker is interacting with the learning system 210 via a desktop or laptop computer (as a “WebUser”) so that the processing may be simplified, although in some embodiments such processing may be performed using a mobile device.

As used herein, a WebUser is a user who, in their primary role, (1) Interacts with the learning system 210 from a PC or smartphone using a web browser over the Internet or an intranet, (2) Logs onto the learning system 210 with a username and password, (3) Requests content by keyword, AltWord or Tag for review, (4) Requests the Next topic on their LearningPath, (5) Browses content on the ContentFramework, (6) Optionally, adds a tag to facilitate later retrieval of reviewed information, (7) Optionally, rates content and adds comments, (8) Optionally, checks their Status on their LearningPath, (9) Optionally, reviews and updates information on their Profile, Group or Supporter.

As used herein, a Supporter is a mobile phone user who, in their primary role: (1) Receives a SMS message from the learning system 210 when the learning system 210 can not directly respond to a request from a mobile device user, (2) Sends a response (“supports the user”) to the mobile device user by text, email, social networking alerts or voice, (3) Collectively, Supporters work with ClientAdmins to augment the content based on frequently requested topics that are currently unavailable and by reacting to feedback on the quality of existing topics.

A number of components or elements are provided which together interact to achieve the desirable results noted above. For example, one component of the system is the learning system 210—the application which controls operation of the system. The learning system 210 provides the following functions: (1)Stores Client information as provided by the SysAdmin including, (a) SMSGateway#, (b) ClientAdmin user name and password, (2) Stores data as provided by the Client such as (a) Valid user information including users, groups and supporter data including names, passwords, phone numbers and email addresses, (b) Prerecorded content (e.g., text, voice and video) and its metadata (keyword, AltWords, Tags, Status, Description, Degree of Difficulty), (c) ContentFramework. (d) LearningPaths, (3) Receives requests from the mobile device user via the SMSGateway or other means such as email, voice or instant messaging (such as via the Web/Data API 236 of FIG. 2), (4) Processes requests and responds as defined in the various use cases presented in this document (e.g., sends information to the mobile device user and Supporter by way of various gateways including text, voice, video and email), (5) Tracks all message traffic (inbound and outbound) in a SysLog file. Under ideal conditions, the SysLog file will identically match the combination of individual TextLog, VoiceLog and VideoLog files. If messages are undelivered or ‘lost’ the SysLog enables diagnostic tracing to identify root cause issues and facilitate problem resolution. The SysLog also enables Client specific utilization reporting and billing and payments to the various gateway suppliers for their messaging services.

Another component is the SMSGateway which is a 2-way SMS service provider that: (1) Receives messages (i.e., TextIn) from a mobile device user, (2) Sends information (e.g., mobile device user# and TextIn message) to the learning system 210, (3) Receives information (e.g., mobile device user# or ClientUser#List and TextOut message) from the learning system 210, (4) Sends messages (i.e., TextOut) to a mobile device user, (5) Successful delivery of a TextOut message is logged in the TextLog file with a TimeStamp indicating delivery date and time and recipient information, (6) Receipt of information (i.e., TextIn) is logged in the TextLog file with a reception TimeStamp and recipient information, (7) Records activity in a TextLog file to track utilization and billing.

Another component is the VoiceGateway, which is a voice service provider that: (1) Stores prerecorded audio files (e.g., WAV) each identified by a unique VoiceOutID, (2) Receives information (e.g., mobile device user# or ClientUser#List and VoiceOutID message) from the learning system 210, (3) Retrieves the appropriate prerecorded voice message (i.e., matching VoiceOutID) and delivers the voice message to the mobile device user, (4) Successful delivery is logged in the VoiceLog file with a delivery TimeStamp and recipient information, (5) If no matching VoiceOutID is found, the learning system 210 is alerted to a “no message found” fault.

Another component is the VideoGateway which is a video service provider that: (1) Stores prerecorded video stream files (e.g., MP4) each identified by a unique VideoOutID, (2) Receives information (e.g., mobile device user# or ClientUser#List and VideoOutID message) from the learning system 210, (3) Retrieves the appropriate prerecorded video stream (i.e., matching VideoOutID) and delivers the video stream to the mobile device user, (4) Successful delivery is logged in the VideoLog file with a delivery TimeStamp and recipient information, (5) If no matching VideoOutID is found, the learning system 210 is alerted to a “no message found” fault.

Prior to a further description of the operation of some embodiments, a brief set of illustrative conditions (that will be assumed to be present in the operation of the following description) will be provided. For example, for operation, the following items may be true: (1) Business Case Preconditions: (a) Billing Agreements are in effect (established cost per message is set) with clients, (b) Payment Agreements are in effect (established cost per message is set) with Gateway suppliers, (2) the learning system 210 is operational, (3) Inbound 10-digit number (or shortcode) for the SMSGateway is assigned, (4) SMSGateway and TextLog file are operational, (5) VoiceGateway and VoiceLog file are operational, (6) VideoGateway and VideoLog file are operational, (7) mobile device users are registered, (8) A Supporter is assigned to each mobile device user, (9) a LearningPath is assigned to each mobile device user, (10) Content is available in ContentFramework, (11) Prerecorded voice messages (e.g., WAV files) have been stored with the VoiceGateway supplier, (12) Prerecorded video messages (e.g. MP4 files) have been stored with the VideoGateway supplier, (13) Appropriate error messages are in place to handle the unfulfilled preconditions.

A first use case will now be described in which an SMSGateway is used. In such an embodiment, the following messages may be transmitted in an interaction:
1. Receive-Message. The trigger for this is the receipt of an inbound text message. The TimeStamp, mobile device user# and TextIn information are (a) Recorded in the TextLog file, and (b) Sent to the MobApp via a SOAP message.
2. Send-Message (text). The trigger for this is the receipt of a SOAP message from the learning system 210 that includes a TextOut message and a mobile device user#. The SMSGateway: (a) Sends the TextOut message to the mobile device user#. (b) Records the TimeStamp, mobile device user# and TextOut information in the TextLog file.
3. Broadcast-Message (text). The trigger for this is the receipt a SOAP message from the learning system 210 which includes a TextOut message and a ClientUser#List. The SMSGateway: (a) Sends the TextOut message to each mobile device user# in the ClientUser#List. (b) Records the TimeStamp, User# and TextOut information in the TextLog file for each mobile device user.
4. Send-TextLog. The trigger for this is the receipt of a SOAP message from the learning system 210 which requests the TextLog file for a period of time (e.g., from Date A to Date B inclusive). The SMSGateway sends a copy of the TextLog file to the learning system 210.

Post Conditions. For use case 1-3 above, the TextLog file is updated with inbound and outbound text messages with TimeStamp of activity.

Another component of the system is a VoiceGateway. A number of illustrative use cases for the VoiceGateway include:
1. Send-Message (voice). The trigger for this is the receipt of a SOAP message from the learning system 210 that includes a VoiceOutID and a mobile device user#. The VoiceGateway: (a) Sends the VoiceOutID message to the mobile device user#. (b) Records the TimeStamp, mobile device user# and VoiceOutID information in the VoiceLog file.
2. Broadcast-Message (voice). The trigger for this is the receipt a SOAP message from the learning system 210 which includes a VoiceOutID and a ClientUser#List. The VoiceGateway: (a) Sends the VoiceOutID message to each mobile device user# in the ClientUser#List. (b) Records the TimeStamp, User# and VoiceOutID information in the VoiceLog file for each mobile device user.
3. Send-VoiceLog. The trigger for this is the receipt of a SOAP message from the learning system 210 which requests the VoiceLog file for a period of time (e.g., from Date A to Date B inclusive). The VoiceGateway sends a copy of the VoiceLog file to the learning system 210.
4. Store-Message. The trigger for this is the receipt of a SOAP message from the learning system 210 that includes a new, unique VoiceOutID and WAV file (or alternative digitally encoded audio bitstream). The VoiceGateway (a) Stores the WAV file for subsequent retrieval. (b) Updates the VoiceLog with new file stored. (c) Sends a SOAP message to learning system 210 acknowledging successful storage of VoiceOutID.

Post Conditions for the VoiceGateway use case include the following. For the use cases 1-3 described above, the VoiceLog file is updated with inbound and outbound text messages with TimeStamp of activity. For use case 4, an additional voice message is now available for delivery from the VoiceGateway.

Another component of the system is a VideoGateway. A number of illustrative use cases for the VideoGateway include:
1. Send-Message (video). The trigger for this is the receipt of a SOAP message from the learning system 210 that includes a VideoOut message and a mobile device user#. The VideoGateway: (a) Sends the VideoOut message to the mobile device user#. (b) Records the TimeStamp, mobile device user# and VideoOut information in the VoiceLog file.
2. Broadcast-Message (video). The trigger for this is the receipt a SOAP message from the learning system 210 which includes a VideoOut message and a ClientUser#List. The VideoGateway: (a) Sends the VideoOut message to each mobile device user# in the ClientUser#List. (b) Records the Date, Time, User# and VideoOut information in the VideoLog file for each mobile device user.
3. Send-VideoLog. The trigger for this is the receipt of a SOAP message from the learning system 210 which requests the VideoLog file for a period of time (e.g., from Date A to Date B inclusive). The VideoGateway sends a copy of the VideoLog file to the learning system 210.
4. Store-Message. The trigger for this is the receipt of a SOAP message from the learning system 210 that includes a new, unique VideoOutID and MP4 file (or alternative digitally encoded video bitstream). The VideoGateway: (a) Stores the MP4 file for subsequent retrieval. (b) Updates the VideoLog with new file stored. (c) Sends a SOAP message to learning system 210 acknowledging successful storage of VideoOutID.

Post Conditions for the VideoGateway use case include the following. For the use cases 1-3 described above, the VideoLog file is updated with inbound and outbound text messages with TimeStamp of activity. For use case 4, an additional video message is now available for delivery from the VideoGateway.

Another component of the system is a SysAdmin. A number of illustrative use cases for the SysAdmin include:
1. Add-Client (Key Success Case). The trigger for this is receipt of a business agreement (purchase order) from a client to initiate service. The SysAdmin: (a) Assigns a 10-digit SMSGateway# to the client. (b) Creates a ClientAdmin account consisting of username and password to grant access to the learning system 210. (c) Creates (empty) databases for client content and user records. (d) Adds the ClientAdmin as the first mobile device user. (e) Alerts the ClientAdmin that the learning system 210 is ready.
2. Request-Logfile. The trigger for this a need for usage reports to support client billing or supplier payments. The SysAdmin extracts usage information from the SysLog file for a specific time period either on a: (a) per client basis for client billing, or (b) per gateway basis for supplier payments.
3. Bill-Client. The trigger for this is a periodic (e.g., monthly) billing date. The SysAdmin compares the usage report for client activity to the purchase agreement and determines the amount to be invoiced to the client.
4. Pay-Supplier. The trigger for this is a supplier invoice. The SysAdmin compares the usage report for all Gateway activity to the purchase agreement and verifies the amount to be paid to the suppliers.

Post Conditions for the SysAdmin use case include the following. For use case 1, a new client is ready to populate their database with content and add users. For use case 2, information is now available to support client billing or supplier payment. For use case 3, information is now available to bill a payment. For use case 4, information is now available to pay s supplier.

Another component of the system is a ClientAdmin. A number of illustrative use cases for the ClientAdmin include:

### User Administration

1. Add-User (Key Success Case). The trigger for this is the need to add one or more new users to the mobile device user list for the client's use of the learning system 210. The ClientAdmin: (a) Logs into the learning system 210 with the username and password supplied by the SysAdmin. (b) Opens the “Add New User” form. (c) Adds the user name, email, mobile phone number, language preference and any optional user information and notes. (d) Optionally, adds a Supporter Mobile Phone number. (e) Optionally, adds a Learning Path name. (f) Optionally, adds a Group name. (g) Saves the form to create a new database record for the mobile device user.
2. Add-Group. The trigger for this is the need to add one or more new groups to the learning system 210. The ClientAdmin: (a) Logs into the learning system 210 with the username and password supplied by the SysAdmin. (b) Opens the “Add New Group” form. (c) Adds a name for the Group. (d) Saves the form to create a new database record for the learning system 210.
3. Broadcast-Message. The trigger for this is a need (e.g., new content has been added) to send one or more alerts to individual users, user groups or all mobile device users for the client. The ClientAdmin: (a) Logs into the learning system 210 with the username and password supplied by the SysAdmin. (b) Opens the “Broadcast Message” form. (c) Selects individual users, groups or all from the valid mobile device user list. (d) Composes the message. (e) Clicks on “Send Now” or “Send Later” button. If “Send Later” is chosen, then the date and time is also entered. (f) Clicks on “Save and Send” or “Cancel” to close the form. The learning system 210 completes the process by sending the broadcast message.

### Content Administration

4. Add-Content (Key Success Case). The trigger for this is the need to an additional subject, topic or sub-topic to the content database. The ClientAdmin: (a) Logs into the learning system 210 with the username and password supplied by the SysAdmin. (b) Opens the “Add New Content” form. (c) Enters a required Keyword. (d) Optionally, enters one or more Altwords. (e) Selects “Type” (text, voice or video). (f) Browses to the appropriate file and selects that file to be uploaded to the learning system 210. (g) Selects the appropriate status as “in-process”, “approved” or “released”. (h) Optionally, adds a description. (i) Assigns a degree of Difficulty from 0 to 10. (j) Clicks on “Save”, “Save & Add Another” or “Cancel”.

If the content is in the “Released” status, and triggered by either Save command: (a) And if the “Type” is Text, the learning system 210 now allows this information to be requested by mobile device users. (b) Or if the “Type” is “Voice” or “Video”, the learning system 210 sends the VoiceOut or Video0ut file to the appropriate gateway and then allows this information to be requested by mobile device users.
5. Build-ContentFramework. The Trigger for this is the need to provide mobile device users with a structured construct to link the various topics together into a more cohesive conceptual entity. The ClientAdmin: (a) Logs into the learning system 210 with the username and password supplied by the SysAdmin. (b) Opens an empty “Build ContentFramework” form. (c) Beginning with Subject 1 the ClientAdmin selects from the available content a keyword that, upon selection, replaces Subject 1. (d) An additional Subject may then be entered as chosen from additional keywords. (e) Topics may be added as subordinate to existing Subjects again based upon available keywords. (f) Sub-topics may be added as subordinate to existing Topics again based upon available keywords. (g) Sub-topics may be “promoted” to Subjects and Subjects may be “demoted” to topics or sub-topics as required to build a comprehensible ContentFramework. (h) When completed, the ClientAdmin may select “Save” or “Cancel”.

The learning system 210 now enables WebUsers to browse the ContentFramework with a web browser on a PC or mobile smartphone.
6. Add-LearningPath. The Trigger for this is the need to provide individuals or select groups of mobile device users (e.g., new hires) with a construct to link various topics together into a simplified (as compared to the ContentFramework) conceptual entity. The ClientAdmin: (a) Logs into the learning system 210 with the username and password supplied by the SysAdmin. (b) Opens the “Add LearningPath” form. (c) Enters a name for the LearningPath, (d) Beginning with Subject 1 the ClientAdmin selects from the available content a keyword that, upon selection, replaces Subject 1. (e) An additional Subject may then be entered as chosen from additional keywords. (f) Topics may be added as subordinate to existing Subjects again based upon available keywords. (g) Sub-topics may be added as subordinate to existing

Topics again based upon available keywords. (h) Sub-topics may be “promoted” to Subjects and Subjects may be “demoted” to topics or sub-topics as required to build a comprehensible LearningFramework. (i) When completed, the ClientAdmin may select “Save” or “Cancel”

The learning system 210 now enables a mobile device user to review their LearningPath and check their Status.

Post Conditions for the ClientAdmin use case include the following. For User Administration: (a) For use case 1, a new Client is ready to populate their database with content and add users. (b) For use case 2, a new group is established. (c) For use case 3, a Client delivers a broadcast message to one or more mobile device users. For Content Administration: (a) For use case 4, new content is now available in the content database. (b) For use case 5, a ContentFramework is established. (c) For use case 6, a new LearningPath is now available.

Another component of the system is a mobile device user. A number of illustrative use cases for the mobile device user include:
1. Request-Content (Key Success Case). The trigger for this is receipt of a valid Keyword, Altword or Tag as a TextIn message from the mobile device user. The learning system 210 compares the TextIn to all valid Keywords, Altwords, Tags and SysWords and, in this success case, finds a successful match. If the match is a topic with content stored as: (a) Text, then a TextOut message is sent to the mobile device user. (b) Voice, then a VoiceOut message is sent to the mobile device user. (c) Video: (i) If the mobile device user if VideoEnabled, then a VideoOut message is sent to the mobile phone of mobile device user, (ii) Else, the VideoOut message is sent to the UserEmail of the mobile device user.
2. Request-Help (Success Case). The trigger for this is the learning system 210 receiving the SysWord “Help” as a TextIn message from a mobile device user. The learning system 210 compares the TextIn message to all valid Keywords, Altwords, Tags and SysWords and, in this success case, finds a successful match to the SysWord “Help”. The learning system 210 sends the text message “To request content, text a keyword such as: subject_1, subject_2, . . . or subject_N” where N is the total number of subjects in the Clients ContentFramework and subject_1, subject_2, . . . , subject_N are the subjects in the Clients ContentFramework.
3. Request-Help Content (Success Case). The trigger for this is the learning system 210 receiving a TextIn message from a mobile device user consisting of “Help Content_X” where “Content_X” can be a subject, topic or sub-topic. The learning system 210 compares the “Content_X” component of the TextIn message to all valid Keywords, Altwords, Tags and SysWords and, in this success case, finds a successful match to valid content. In the case where “Content_X” has subordinate topics, then the learning system 210 sends the text message “Content_X consists of topics “topic_1”, “topic_2”, . . . or “topic_M”” where M is the total number of topics which are subordinate to “Content_X” and “topic_1”, “topic_2”, . . . , “topic_M” are the keywords for the topics subordinate to “Content_X” in the ContentFramework. In the case where “Content_X” has no subordinate topics, then the learning system 210 sends the text message “Content_X has no topics, to request its content just text “Content_X”. In the case where the “Content_X” component of the TextIn message is a match to valid SysWord such as “rate” then a text message “You may rate any topic, just text “rate topic as # comment” where # is 0 to 10 followed by a comment” is sent to the mobile device user in support of the following use case. Similar help messages in support of all SysWords are also provided.
4. Rate-Content (Success Case). The trigger for this is the learning system 210 receiving a TextIn message from a mobile device user consisting of “Rate Content_X as Integer_Y Optional_Comment_Z” where (a) “Content_X” can be a subject, topic or sub-topic, (b) “Integer_Y” is an integer from 0 to 10 inclusive, (c) “Optional_Comment_Z” is an optional string of text expressing the mobile device user's comment. The learning system 210 parses the “Content_X” component out of the TextIn message and compares it to all valid Keywords, Altwords, Tags and SysWords and, in this success case, finds a successful match to valid content. The learning system 210 parses the “Integer_Y” component out of the TextIn message and, in this success case, finds a successful match to an integer from 0 to 10 inclusive. The learning system 210 parses the “Optional_Comment_Z” component out of the TextIn message and, in this success case, finds an optional text string. The learning system 210 then records the mobile device user's rating of “Content_X as “Integer_Y with comments of “Optional_Comment_Z” into the Clients' database for further analysis.
5. Tag-Topic (Success Case). The trigger for this is the learning system 210 receiving a TextIn message from a mobile device user consisting of “Tag Content_X as My_Tag” where: (a) “Content_X” can be a subject, topic or sub-topic, (b) “My_Tag” is a string of text, typically a single word, known as a social or collaborative tag. The learning system 210 parses the “Content_X” component out of the TextIn message and compares it to all valid Keywords, Altwords, Tags and SysWords and, in this success case, finds a successful match to valid content. The learning system 210 parses the “My_Tag” component out of the TextIn message and compares it to all valid Keywords, Altwords, Tags and SysWords and, in this success case, finds no matches to valid content which means “My_Tag” text is available for use as a tag. The learning system 210 then takes one of two actions to the mobile device user: (a) If the tag is available, “Thank you for your tag.” The learning system 210 then records the mobile device user's tag of “Content_X as “My_Tag” into the Clients' database to facilitate retrieval by other users. (b) If the tag is unavailable (“My_Tag” is already in use), “Sorry, that tag is already in use.” Note: System help message for “Help Tag” is “You may add a tag any topic by texting “Tag topic as MyTag”.

Check-Status (Success Case). The trigger for this is receipt of the SysWord (“Status”). The learning system 210 queries the Clients' database for the LearningPath of the mobile device user. Upon retrival of the LearningPath, the learning system 210 computes the “Status” as the user's percent completion (meaning the topic has been requested at least once) of the LearningPath where a Difficulty factor is used to apply a weighting factor to each topic. For example, if the Learning Path has 20 “moderately difficult” topics of Difficulty 5 (20×5=100) and 25 “relatively easy” topics of Difficulty 2 (25×2=50) the total LearningPath has a rating of 150. If 10 “moderately difficult” topics (10×5=50) and 10 “relatively easy” topics (10×2=20) were retrieved, the total completion is 70. The status is 70 out of 150 or 47%. The learning system 210 then sends a text message to the user, “You have completed ‘Status’ of your Learning Path.”
6. Request-Next. The trigger for this is receipt of the SysWord “next” as a TextIn message from the mobile device user. The learning system 210 determines if the mobile device user has a LearningPath. If the Learning path is completed, the learning system 210 sends a TextOut message indicating that the LearningPath has been completed. If the Learning path is not yet completed, the learning system 210 retrieves the LearningPath for the mobile device user. The learning system 210 identifies the next topic. If the next topic is (i) Text, then a TextOut message is sent to the mobile device user, (ii) Voice, then a VoiceOut message is sent to the mobile device user, (iii) Video, If the mobile device user if VideoEnabled, then a VideoOut message is sent to the mobile phone of mobile device user, Else, the VideoOut message is sent to the UserEmail of the mobile device user.
7. Check-Support and Change-Support. The trigger for this is receipt of the SysWord “support” as a TextIn message from the mobile device user. If there is no additional text, then the learning system 210 sends the mobile device user a message similar to the following: “support name” can be reached at “MobiSupport#”. If the TextIn is “support off' messages to the Supporter are disabled. If the TextIn is “support on” and if a supporter has been assigned then messages to the Supporter are enabled. If the TextIn is “support MobiSupport#” then support messages are routed to the MobiSupport#” provided that is a ClientAdmin validated mobile number.

Post Conditions for the mobile device user use case include the following. For use case 1, content has been delivered to a mobile device user and if that content was on their LearningPath, their Status is updated. For use case 2, a help message is delivered to the mobile device user. For use case 3, a mobile device user rates a topic and optional comments are captured. For use case 4, a mobile device user has added a tag. For use case 5, a mobile device user received a Status update on their progress towards completing their LearningPath. For use case 6, the Next topic a mobile device user's LearningPath was delivered. For use case 7, the mobile device user has checked, enabled, disabled or connected themselves to a new Supporter.

Another component of the system is a WebUser. A number of illustrative use cases for the WebUser include:
1. Log-In. The trigger for this is a user browsing to the URL of the learning system 210 website on the Internet or intranet of a client. The mobile device user enters their UserName and Password and clicks Log in. If authentication is successful the user is presented with a welcome screen. The user may return to the welcome page at any time by clicking on the “Welcome” button located on the navigation panel on the left hand side of the screen.
2. Request-Content. The trigger for this is a user typing in a valid keyword, AltWord or Tag into the request box and clicking on the “Submit” button. The learning system 210 compares the TextIn to valid Keywords, Altwords and Tags and finds a successful match. Upon success (valid keyword, AltWord or Tag) the learning system 210 displays the requested content. If the match is: (a) Text, then the TextOut message is displayed, (b) Voice, then a VoiceOut icon is displayed which, when clicked, plays back the prerecorded audio sound file through the speakers or earphones of the device (PC or smartphone), (c) Video, then a Video icon is displayed which, when clicked, plays back the prerecorded video file through the monitor (PC) or screen (smartphone) of the device.
3. Rate-Topic (add comment). The trigger for this is a user selecting one of the eleven check boxes (an integer from 0 to 10), adding an optional comment in the text box provided and clicking on the “Submit” button (e.g., as an example, a user may decide to rate the topic as an “8” and add a comment—“a good technical overview but lacked any competitive impact” which points to a need to provided better competitive positioning). User rating and the optional user comment are entered into the content database for further analysis.
4. Tag-Topic. The trigger for this is a user typing text such as ‘MyTag’ into the “Add tag” text box and clicking on the Submit button as shown in FIG. 11 (where the User has decided to tag this topic with the speakers last name “Smith” which is intended to facilitate recall by others). The learning system 210 checks to see if “MyTag” is not a system word, keyword, Altword or existing Tag in which case it is considered “available”. If “MyTag” is available, then it is entered into the database and the user is so notified. If “MyTag” is un-available, then the user is notified the proposed tag is unavailable.
5. Request-Help. The trigger for this is a user clicking on the “Help” button on a navigation panel. The learning system 210 may, e.g., display the help content in the middle screen panel.
6. Check-Status. The trigger for this is a user clicking on the “My Status” button (where the user checks their status by clicking on the button and the learning system 210 displays a status indicator under the “My Status” button, in this case showing 86% completion. Clicking on the button again removes the indicator). The learning system 210 queries the database for successful reception of content on the LearningPath for the mobile device user, applies the appropriate Difficulty factor to each item and computes the Status percent of the mobile device user. The learning system 210 then displays an icon indicating percent completion under the “My Status” button. Upon clicking on the “My Status” button, the icon is removed from the screen.
7. View-LearningPath. The trigger for this is a user clicking on the “My Path” button. The learning system 210 displays a collapsed view of the LearningPath that can then be expanded by clicking on the “Expand all” as shown in FIG. 15. The user can click on any topic to display the corresponding text, voice or video. If the user has not completed their LearningPath, the next topic will be highlighted and labeled with a “Go” indicator.
8. Request-Next topic. The trigger for this is may be a user clicking on a “Go” text next to the appropriate topic in the LearningPath.
9. Browse-Content. The trigger for this is a user clicking on the “Browse” button. The learning system 210 displays a collapsed view of the ContentFramework that can then be expanded by clicking on the “Expand all”. The user can click on any topic to display the corresponding text, voice or video.
10. View-Profile (and update). The trigger for this is a user clicking on a “My Profile” button. The learning system 210 displays the user profile and the user can make any necessary changes. In this use the mobile device user can assist or complete many ClientAdmin functions.
11. View-Support (and update). The trigger for this is a user clicking on the “My Support” button. The learning system 210 displays the following information: “support name” can be reached at “MobiSupport#”. The learning system 210 prompts the user for any changes in support including: (a) In the case support is enabled, “Support Off” in which case messages to the Supporter are disabled, (b) In the case support is disabled, “Support On” in which case messages to the Supporter are enabled, (c) “Change Supporter” in which case the user is prompted for a new MobiSupport#. If a new number is entered and submitted the learning system 210 changes support messaging to that new number provided that the new number is a valid mobile device user number.
12. View-Group (and broadcast message). The trigger for this is a user clicking on the “My Group” button. The learning system 210 displays a list of Group names and members of those Groups. The user may compose a message to send to any group, enter the message text, select “text” or “email” and broadcast that message to the selected group
13. Log Out. The trigger for this is a user clicking on a “Log out” button (where the user has clicked on a log out button and has been returned to the login screen). The learning system 210 logs the WebUser out and refreshes the screen back to a “Welcome” screen.

Post Conditions for the WebUser use case include the following. For use case 1, the WebUser successfully authenticates to the learning system 210 web site. For use case 2, text, voice or video content is presented to the WebUser and their LearningPath is updated. For use case 3, a WebUser has rated a topic and optional comments are captured to help the client improve the content of their database. For use case 4, a WebUser has added a tag to help other users find content. For use case 5, a WebUser received “Help” on use of the learning system 210. For use case 6, the WebUser is shown their Status towards completion of their LearningPath. For use case 7, the WebUser is shown their LearningPath. For use case 8, the next topic on the LearningPath is shown to the WebUser and their LearningPath is updated. For use case 9, the WebUser is shown the ContentFramework. For use case 10, the WebUser is shown their profile and can optionally provide updates. For use case 11, the WebUser is shown the name and number of their assigned supporter. The WebUser could have (temporarily) disabled support, (re-) enabled support or connected himself or herself to a new supporter. For use case 12, the WebUser is shown the names of any groups in which they have membership. For those groups, they are also shown the names of other members and their phone numbers. Optionally, they may broadcast a message to any group or individual member. For use case 13, the WebUser successfully logs out of the learning system 210 web site.

One or more “Supporters” may also be provided in a system pursuant to embodiments of the present invention. A number of Supporter user cases may be provided.
1. Offer-Support (Key Success Case). The trigger for this is receipt of a text message from the learning system 210 that indicates a mobile device user has requested support on a topic that is not in the ContentFramework. The Supporter receives the following message: “A request text of ‘unsupported request’ from ‘Name of mobile device user’ was received on ‘TimeStamp’. Please call or text ‘123-456-7890’ to offer support.” The Supporter is thus advised to offer support to a mobile device user and can provide such support via phone, email, other communications protocols, or text to offer support. The learning system 210 records the ‘unsupported request’ in the SysLog.

Post Conditions for the Supporter use case include the following. For use case 1, the learning system 210 successfully advises a Supporter that a mobile device user needs support. The message is recorded in the SysLog file.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Embodiments may be used to conduct assessments, including use cases for the ClientAdmin of Create-Test and Send-Test and for the mobile device user of Request-Test and Take-Test. Further, embodiments may be used to conduct surveys, including use cases for the ClientAdmin of Create-Survey and Send-Survey and for the mobile device user of Request-Survey and Take-Survey. Embodiments may also be used for search, including use cases for the e mobile device user of Search-Content where a keyword, AltWord or Tag is not required to retrieve content. In some embodiments, an automated welcome page may be provided which creates a Welcome Page for WebUser automatically based on most highly rated content. Further, an automated reporting feature may be provided which creates periodic reports on such items as LearningPath progress, utilization and highest and lowest rated content.

In some embodiments, a group status may be provided in which a status rating for various groups may be created. In some embodiments, a LearningPath for a specific period of time may be created and status versus time may be tracked with automated prompts to the mobile device user if they are moving too slowly through their LearningPath. In some embodiments, WIKI (“What I know Is”) or User Submitted Content may be included, offering the Add-Content capability (now available to ClientAdmin) to users effectively creates a WIKI capability to the learning system 210. Further, Instant Messaging support for mobile device user requests and responses may be provided as well as email support (e.g., where a Supporter may request email messages instead of text messages). In some embodiments, social networking or other alert formats may also be used to transmit information among users.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method for delivering information, comprising:
transmitting a notification of a learning path to at least one of a plurality of users, each of said users operating a mobile device, said notification including a message associated with said learning path;
receiving, from said at least one of a plurality of users, a first message in response to said notification;
identifying, based on said first message, a status of said user; and
identifying, based on said first message and said status of said user, a response to said first message.

2. The method of claim 1, wherein said notification is transmitted as at least one of an SMS message, a phone call, and an email.

3. The method of claim 1, wherein said first message in response to said notification is received as an SMS message.

4. The method of claim 1, wherein said status of said user includes information identifying said user.

5. The method of claim 1, wherein said status of said user includes information identifying a current progress of said user in said learning path.

6. The method of claim 1, wherein said identifying a response to said first message further comprises:
parsing said first message to determine if said first message includes at least one of a keyword, an altword, and a tag.

7. The method of claim 6, where said first message includes a keyword, the method further comprising:
constructing a database query using said keyword;
searching a database associated with said learning path using said database query; and
returning a result of said database query to said user as said response to said first message.

8. The method of claim 6, wherein said first message includes a keyword, the method further comprising:
constructing a database query using said keyword;
searching a database associated with said learning path using said database query;
determining that no result is available from said database query; and
returning a message to said user indicating that no query result is available for said keyword as said response to said first message.

9. The method of claim 8, wherein said message to said user includes a prompt for said user to confirm their interest in a live support connection.

10. The method of claim 9, further comprising:
receiving a confirmation from said user for a live support connection;
determining, based on said keyword and said learning path, an appropriate support representative; and
establishing a connection between said user and said appropriate support representative.

11. The method of claim 8, further comprising:
logging said keyword in a database for generation of future content.

12. The method of claim 6, where said first message includes an altword, the method further comprising:
determining, based on said altword, a navigational action; and
performing said navigational action to identify a learning object;
wherein said response to said first message includes data associated with said identified learning object.

13. The method of claim 12, wherein said navigational action is one of (i) a navigation to a next learning object in said learning path, (ii) a navigation to a previous learning object in said learning path, and (iii) a jump to a specified learning object in said learning path.

14. The method of claim 6, wherein said first message includes an altword, the method further comprising:
determining, based on said altword, a data retrieval action; and
performing said data retrieval;
wherein said response to said first message includes data retrieved by said data retrieval action.

15. The method of claim 14, wherein said data retrieval action is one of (i) a request for a document, (ii) a request for a video, (iii) a request for a voice file, (iv) a request for a self assessment, and (v) a request for a quiz.

16. A method for operating a mobile device, comprising:
receiving a text message including a notification of a learning path, the text message including information associated with a first learning object in said learning path;
sending a response to said text message, said response including a request for further information, the response including a command, the command at least one of (i) a keyword, (ii) an altword, and (iii) a tag; and
receiving, based on said response, said further information.

17. The method of claim 16, wherein said command is a keyword, wherein said further information includes at least one of (i) a learning object associated with said keyword, (ii) a prompt to confirm establishment of a live support connection.

18. The method of claim 17, further comprising:
confirming establishment of a live support connection; and
receiving at least one of a voice connection and a data connection with a live support representative.

19. The method of claim 16, wherein said command is a navigational command, wherein said further information includes data associated with a learning object identified by said navigational command.
